(19) United States
(12) Patent Application Publication
(10) Pub. No.: US 2026/0003747 A1
(43) Pub. Date: Jan. 1, 2026

(54) BACKUP SYSTEM AND BACKUP METHOD

(71) Applicant: Hitachi Vantara, Ltd., Yokohama-shi (JP)

(72) Inventor: Hideaki YAJIMA, Tokyo (JP)

(73) Assignee: Hitachi Vantara, Ltd., Yokohama-shi (JP)

(21) Appl. No.: 19/077,566

(22) Filed: Mar. 12, 2025

(30) Foreign Application Priority Data
Jun. 26, 2024 (JP) 2024-103003

(51) Int. Cl. G06F 11/20; G06F 11/16

(52) U.S. Cl. CPC G06F 11/2023; G06F 11/1612; G06F 11/2082

(57) ABSTRACT

A backup system includes a plurality of backup storage devices for storing backup data of backup target data stored in a storage device. The plurality of backup storage devices are classified as backup storage devices belonging to either a primary layer or a secondary layer. In the backup system, the backup target data is backed up by the storage device storing primary backup data, which is backup data of the backup target data, in the backup storage device belonging to the primary layer, and the backup storage device belonging to the primary layer storing secondary backup data, which is backup data of the primary backup data, in the backup storage device belonging to the secondary layer.

### BACKGROUND OF THE INVENTION

### 1. Field of the Invention

The present invention relates to a backup system and a backup method.

### 2. Description of the Related Art

The backup 3-2-1 rule is a common strategy to ensure data safety. The backup 3-2-1 rule is configured as follows (1) to (3). (1) Having three copies. This means having original data and two copies of backup data. (2) Storing the backup data on two different kinds of storage devices. (3) Storing one copy of backup data off-site. The at least one copy of backup is stored at a location physically away from a current location.

By complying with the backup 3-2-1 rule, a risk of data loss can be significantly reduced.

JP 2017-102834 A discloses a backup system that, when a failure of a current site is detected, selects, from a plurality of backup sites, a backup site that satisfies a predetermined condition (a maximum number of users and a maximum usage amount regarding a remaining capacity of the backup site) such as an operation policy indicating priorities of the backup sites each having a standby system database and a current usage status, and automatically switches the backup site to the selected site, thereby appropriately maintaining redundancy of the database.

JP 2010-157145 A discloses that a storage device establishes a connection between a volume (second volume) included in the storage device and a volume (first volume) of a backup device to remotely copy data of the second volume to the first volume or to copy data equivalent to data of the first volume to a volume (third volume) including a free area of the backup device in response to a server-issued copy setting command (=backup of backup data).

### SUMMARY OF THE INVENTION

The inventors of the present application and the like are considering arranging a plurality of copies of backup data in a plurality of storage devices and performing a backup operation so as to comply with a predetermined arrangement rule. In this case, due to a failure of the storage device or a connection failure between the storage devices, it may become impossible to comply with the arrangement rule of the backup data, making it impossible to maintain a robustness of the backup operation.

The present invention has been made to solve the above problem. That is, an object of the present invention is to provide a backup system and a backup method capable of maintaining a robustness of a backup operation.

In order to solve the above problems, the backup system of the present invention is a backup system including a plurality of backup storage devices for storing backup data of backup target data stored in a storage device. The plurality of backup storage devices are classified as backup storage devices belonging to either a primary layer or a secondary layer, and the backup target data is backed up by the storage device storing primary backup data, which is backup data of the backup target data, in the backup storage device belonging to the primary layer, and the backup storage device belonging to the primary layer storing secondary backup data, which is backup data of the primary backup data, in the backup storage device belonging to the secondary layer.

The backup method of the present invention is a backup method using a plurality of backup storage devices for storing backup data of backup target data stored in a storage device. The plurality of backup storage devices are classified as backup storage devices belonging to either a primary layer or a secondary layer, and the backup target data is backed up by the storage device storing primary backup data, which is backup data of the backup target data, in the backup storage device belonging to the primary layer, and the backup storage device belonging to the primary layer storing secondary backup data, which is backup data of the primary backup data, in the backup storage device belonging to the secondary layer.

According to the present invention, the robustness of the backup operation can be maintained. Note that the effects described herein are not necessarily limited, and may be any of the effects described in the present disclosure.

### BRIEF DESCRIPTION OF THE DRAWINGS

FIG. 1 is a diagram illustrating a configuration example of a backup system according to a first embodiment of the present invention;

FIG. 2 is a block diagram illustrating an example of a hardware configuration of a storage device;

FIG. 3 is a diagram for describing a monitoring task table;

FIG. 4 is a diagram for describing a condition table;

FIG. 5 is a diagram for describing a backup table;

FIG. 6 is a diagram for describing a BK location table;

FIG. 7A is a diagram for describing a storage layer table;

FIG. 7B is a diagram for describing a recovery task table;

FIG. 8A is a diagram for describing an overview of an operation of a backup system;

FIG. 8B is a diagram for describing an overview of the operation of the backup system;

FIG. 8C is a diagram for describing an overview of the operation of the backup system;

FIG. 8D is a diagram for describing an overview of the operation of the backup system;

FIG. 9A is a flowchart illustrating a flow of processing executed by the backup system;

FIG. 9B is a flowchart illustrating a flow of the processing executed by the backup system;

FIG. 10 is a flowchart illustrating a flow in which the backup system executes switching of a backup destination device of a primary layer;

FIG. 11 is a flowchart illustrating a flow in which the backup system executes switching of a backup destination device of a secondary layer;

FIG. 12 is a diagram for describing an evaluation score table;

FIG. 13A is a flowchart illustrating a flow in which a backup system according to a second embodiment executes primary layer device switching processing;

FIG. 13B is a flowchart illustrating a flow in which the backup system according to the second embodiment executes the primary layer device switching processing;

FIG. 14A is a flowchart illustrating a flow in which the backup system according to the second embodiment executes secondary layer device switching processing;

FIG. 14B is a flowchart illustrating a flow in which the backup system according to the second embodiment executes the secondary layer device switching processing;

FIG. 15 is a flowchart illustrating a flow of processing executed by a backup system according to a third embodiment;

FIG. 16 is a flowchart illustrating a flow of switching to a device before switching;

FIG. 17 is a flowchart illustrating a flow of processing executed by the backup system according to the third embodiment;

FIG. 18 is a flowchart illustrating a flow of switching to a device before switching;

FIG. 19A is a flowchart illustrating a flow of processing executed by a backup system according to a fourth embodiment;

FIG. 19B is a flowchart illustrating a flow of the processing executed by the backup system according to the fourth embodiment;

FIG. 20A is a flowchart illustrating a flow of processing executed by the backup system according to the fourth embodiment; and

FIG. 20B is a flowchart illustrating a flow of the processing executed by the backup system according to the fourth embodiment.

### DESCRIPTION OF THE PREFERRED EMBODIMENTS

Hereinafter, embodiments of the present invention will be described with reference to the drawings.

Note that in all the drawings of the embodiments, the same or corresponding parts may be denoted by the same reference numerals.

In the following description, various types of information may be described using expressions such as “table” and “record”, but various types of information may be expressed using a data structure other than these. In describing identification information, expressions such as “ID”, “name”, and “number” are used, but these can be replaced with each other, and other expressions may be used. Although there is a case where processing is described with a device or a system as a subject, the subject of the processing may be a processor, a program, or a controller instead of the device or the system.

### First Embodiment

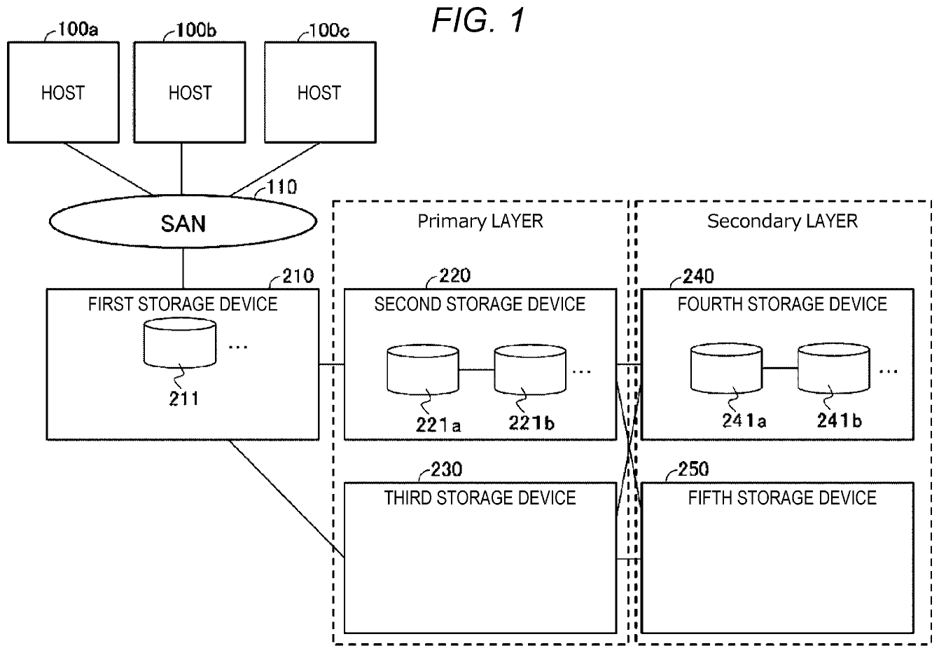

FIG. 1 is a diagram illustrating a configuration example of a backup system according to a first embodiment of the present invention. As illustrated in FIG. 1, the backup system includes hosts 100a to 100c, a first storage device 210, a second storage device 220, a third storage device 230, a fourth storage device 240, and a fifth storage device 250. Hereinafter, the hosts 100a to 100c may be referred to as “hosts 100” in a case where it is not necessary to particularly distinguish between them.

The host 100 is a computer (server device) that issues an IO request. The host 100 may be a physical computer or a virtual computer. The host 100 is connected to a first storage device 210 via a storage area network (SAN) 110. The first storage device 210 includes a plurality of business volumes 211. The host 100 is provided with the business volume 211 from the first storage device 210. The host 100 recognizes the business volume 211 when the business volume 211 is mounted on the host 100.

The second storage device 220 to the fifth storage device 250 are backup storage devices used to store backup data.

The second storage device 220 to the fifth storage device 250 are set (registered, classified) as storage devices belonging to either a primary layer or a secondary layer.

In the backup system, as storage devices that store the backup data, one storage device selected from among storage devices belonging to the primary layer and one storage device selected from among storage devices belonging to the secondary layer are associated with a storage device that holds (stores) backup target data. Note that the storage device that holds (stores) backup target data and the storage device that stores backup data of the backup target data may be referred to as “storage devices having a backup relationship” or “storage devices forming a backup relationship”.

The storage device that holds the backup target data transmits a copy of the backup target data (hereinafter, may be referred to as “primary backup data”) to a storage device belonging to the primary layer and having the backup relationship, and stores the primary backup data in the storage device that belongs to the primary layer.

The storage device that belongs to the primary layer transmits a copy of the primary backup data (hereinafter, may be referred to as “secondary backup data”) to a storage device belonging to the secondary layer and having the backup relationship, and stores the secondary backup data in the storage device that belongs to the secondary layer.

In the example of FIG. 1, the second storage device 220 and the third storage device 230 are set (registered) as the storage devices belonging to the primary layer. The fourth storage device 240 and the fifth storage device 250 are set (registered, classified) as the storage devices belonging to the secondary layer. Note that the backup system may include one or a plurality of other storage devices other than the first storage device to the fifth storage device, and the one or a plurality of other storage devices may be set (registered, classified) as storage devices belonging to either the primary layer or the secondary layer.

The second storage device 220 includes a volume 221a that stores a full backup copy of the business volume 211 of the first storage device 210 and a plurality of volumes 221b that store differential backup data of a place updated from the previous full backup copy. The backup data stored in the volume 221a and the backup data stored in the plurality of volumes 221b are backup data at different time points. The backup data at different time points may be referred to as backup data of different generations. In the second storage device 220, backup data of a predetermined number (plurality) of generations is stored in volumes prepared for the number of generations, respectively.

The fourth storage device 240 includes a volume 241a that stores a full backup copy of the volume 221a and a volume 241b that stores a full backup copy of the volume 221b. The backup data stored in the volume 241a and the backup data stored in the plurality of volumes 241b are backup data at different time points. In the fourth storage device 240, backup data of a predetermined number (plurality) of generations is stored in volumes prepared for the number of generations, respectively.

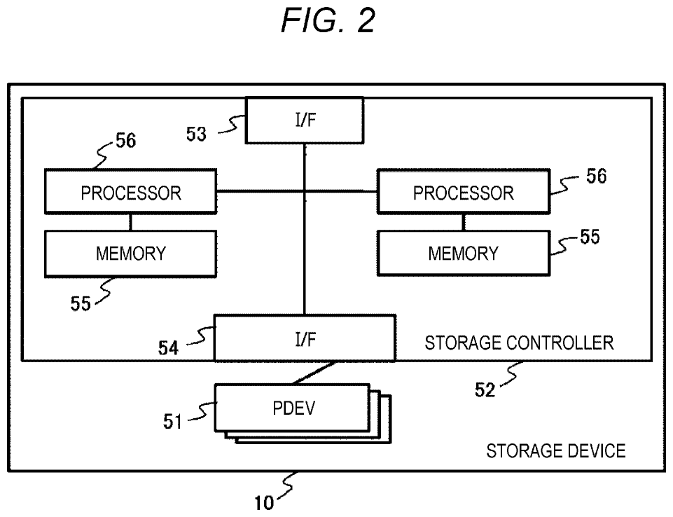

FIG. 2 is a block diagram illustrating an example of a hardware configuration of a storage device. A storage device 10 in FIG. 2 corresponds to each of the first storage device 210 to the fifth storage device 250 in FIG. 1.

The storage device 10 includes PDEVs 51 that are a plurality of (or one) physical storage devices (for example, a drive such as a solid state drive (SSD) or a hard disk drive (HDD)) and a storage controller 52 that is connected to the PDEVs 51. The plurality of PDEVs 51 constitute a plurality of volumes which are logical storage areas.

The storage controller 52 includes an I/F 53, an I/F 54, two memories 55, and two processors 56 connected thereto.

The I/F 53 is a communication interface device that mediates exchange of data between an external device (for example, the host 100 or another storage device) and the storage controller 52. The first storage device 210 is connected to the host. The first storage device 210 is connected to the second storage device 220 and the third storage device 230. For example, the second storage device 220 is connected to the fourth storage device 240 and the fifth storage device 250. The third storage device 230 is connected to the fourth storage device 240 and the fifth storage device 250.

Note that the host 100 connected to the storage device 10 transmits an I/O request (write request or read request) designating an I/O destination (for example, a logical volume number such as a logical unit number (LUN) or a logical address such as a logical block address (LBA) to the storage controller 52.

The I/F 54 is a communication interface device that mediates exchange of data between the plurality of PDEVs 51 and the storage controller 52. A plurality of PDEVs 51 are connected to the I/F 54.

The memory 55 stores a program executed by the processor 56 and data used by the processor 56. The processor 56 executes a program stored in the memory 55. Note that, in this example, a set of the memory 55 and the processor 56 is duplicated.

Note that the storage device 10 may be a storage device provided by a cloud service.

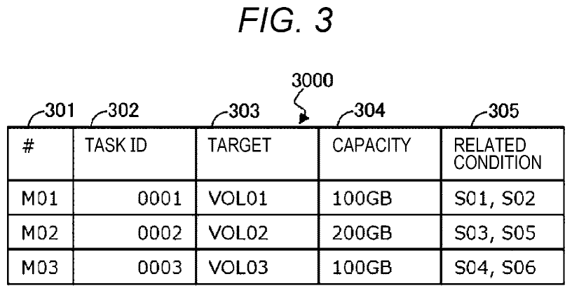

FIG. 3 is a diagram for describing a monitoring task table 3000. The monitoring task table 3000 is stored in the first storage device 210. As illustrated in FIG. 3, the monitoring task table 3000 includes #301, a task ID 302, a target 303, a capacity 304, and a related condition 305 as columns for storing information (values). In the monitoring task table 3000, information corresponding to columns regarding a monitoring task is stored as information (record) in units of rows in association with each other. Specifically, in #301, identification information allocated to the information (record) in units of rows is stored. The task ID 302 stores a task identification number (ID). The target 303 stores identification information of a volume to be monitored. The capacity 304 stores a capacity of the volume to be monitored. The related condition 305 stores a monitoring condition for activating the monitoring task.

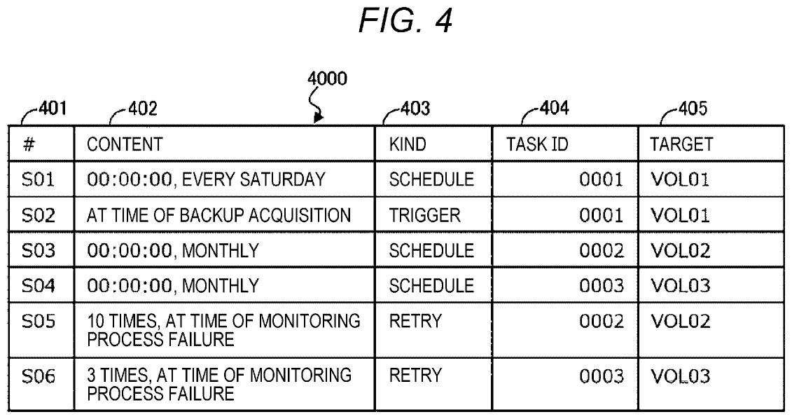

FIG. 4 is a diagram for describing a condition table 4000. The condition table 4000 is stored in the first storage device 210. As illustrated in FIG. 4, the condition table 4000 includes #401, content 402, a kind 403, a task ID 404, and a target 405 as columns for storing information (values). In the condition table 4000, information corresponding to columns regarding the monitoring task is stored as information (record) in units of rows in association with each other. Specifically, in #401, identification information allocated to the information (record) in units of rows is stored. The content 402 stores content of a condition when the monitoring task is activated. The kind 403 stores a kind of the condition when the monitoring task is activated.

The task ID 404 stores an identification number (ID) of the monitoring task to which the condition when the monitoring task is activated is applied. The target 405 stores an identification number of a target volume to which the monitoring task is applied.

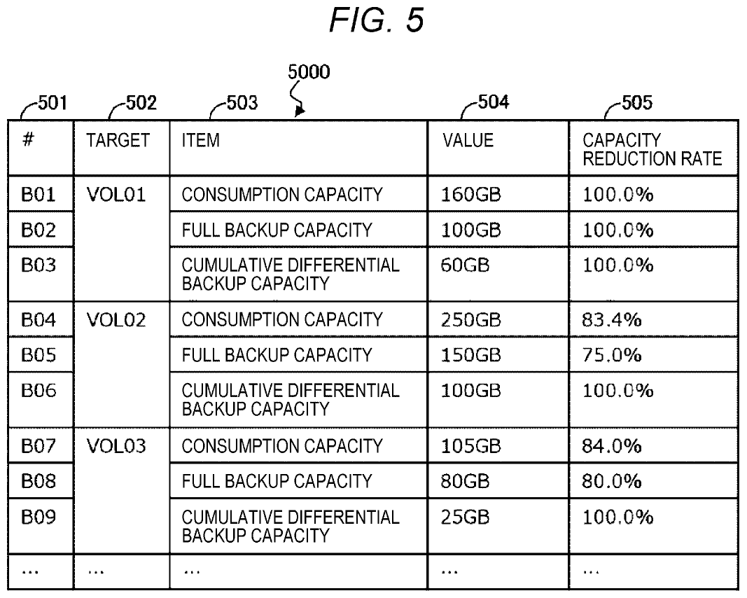

FIG. 5 is a diagram for describing a backup table 5000. The backup table 5000 is stored in the first storage device 210. As illustrated in FIG. 5, the backup table 5000 includes #501, a target 502, an item 503, a value 504, and a capacity reduction rate 505 as columns for storing information (values). In the backup table 5000, information corresponding to columns regarding the backup data is stored as information (record) in units of rows in association with each other. Specifically, in #501, identification information allocated to the information (record) in units of rows is stored. The target 502 stores identification information of a volume in which original data to be backed up is stored. The item 503 stores a kind of a backup capacity. The value 504 stores a capacity of the backup data. The capacity reduction rate 505 stores a capacity reduction rate of backup data in a case where a capacity reduction function is used.

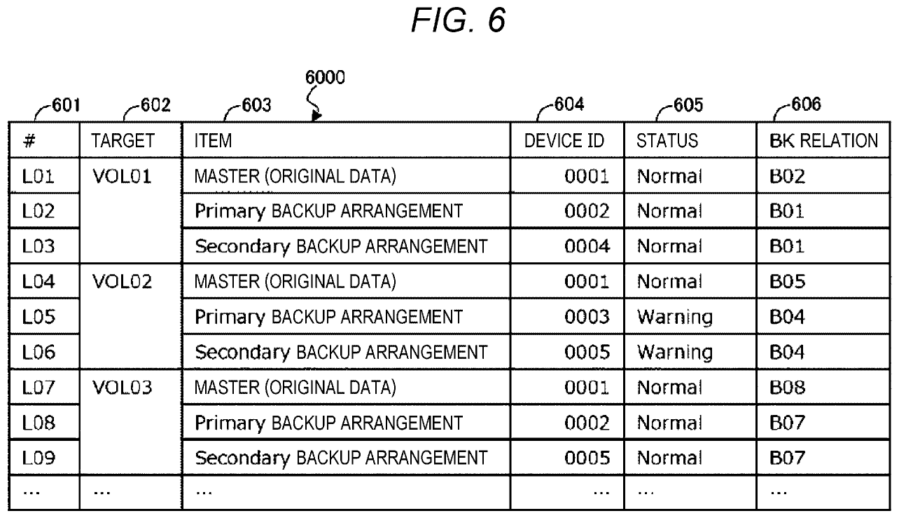

FIG. 6 is a diagram for describing a BK location table 6000. The BK location table 6000 is stored in the first storage device 210. As illustrated in FIG. 6, the BK location table 6000 includes #601, a target 602, an item 603, a device ID 604, a status 605, and a BK relation 606 as columns for storing information (values).

In the BK location table 6000, information corresponding to columns regarding a storage layer and the storage device in which the backup data is arranged is stored as information (record) in units of rows in association with each other. Specifically, in #601, identification information allocated to the information (record) in units of rows is stored. The target 602 stores identification information of a volume in which original data to be backed up is stored. The item 603 stores the storage layer in which the backup data is arranged. The device ID 604 stores an ID of the storage device in which the backup data is stored. In this example, a device ID 0001 indicates the first storage device 210, a device ID 0002 indicates the second storage device 220, a device ID 0003 indicates the third storage device 230, a device ID 0004 indicates the fourth storage device 240, and a device ID 0005 indicates the fifth storage device 250. The status 605 stores information indicating whether or not the backup data is normal. “Normal” indicates that the backup data is normal, and “Warning” indicates that the backup data is abnormal. The BK relation 606 stores an ID of information (record) in units of rows of the backup table 5000.

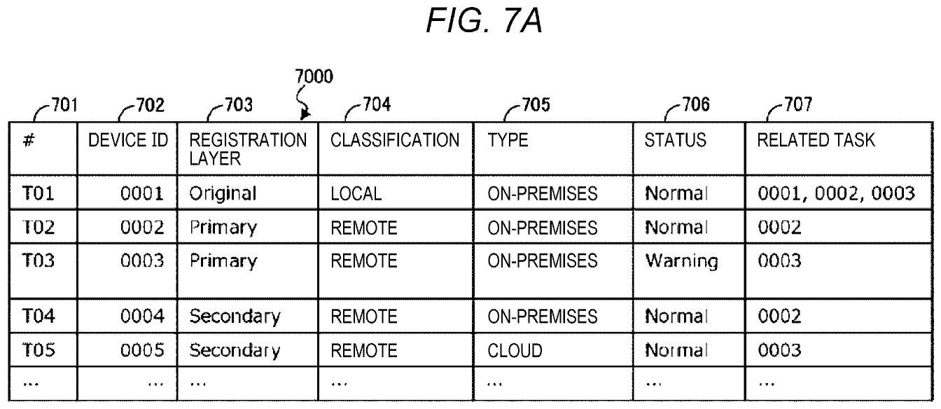

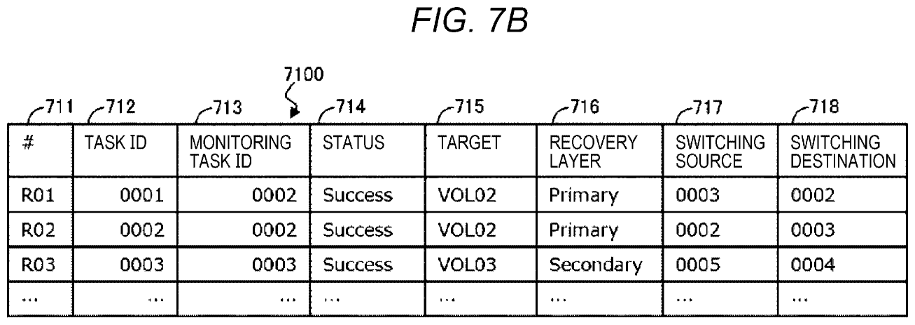

FIG. 7A is a diagram for describing a storage layer table 7000. The storage layer table 7000 is stored in the first storage device 210. As illustrated in FIG. 7A, the storage layer table 7000 includes #701, a device ID 702, a registration layer 703, a classification 704, a type 705, a status 706, and a related task 707 as columns for storing information (values). In the storage layer table 7000, information corresponding to columns regarding the storage device is stored as information (record) in units of rows in association with each other. Specifically, in #701, identification information for identifying information (record) in units of rows is stored. The device ID 702 stores an identification ID of the storage device. A storage layer to which the corresponding storage device belongs is stored in the registration layer 703. The classification 704 stores a kind of the corresponding storage device. The type 705 stores a type of the storage device. “On-premises” indicates that the corresponding storage device is in an on-premises environment. “Cloud” indicates that the corresponding storage device is a storage device provided by a cloud service. The status 706 stores information indicating whether or not the state (including a connection state) of the storage device is normal. The related task 707 stores an ID of the corresponding monitoring task.

FIG. 7B is a diagram for describing a recovery task table 7100. The recovery task table 7100 is stored in the first storage device 210. As illustrated in FIG. 7B, the recovery task table 7100 includes #711, a task ID 712, a monitoring task ID 713, a status 714, a target 715, a recovery layer 716, a switching source 717, and a switching destination 718 as columns for storing information (values). In the recovery task table 7100, information corresponding to column regarding a history of the recovery task is stored as information (record) in units of rows in association with each other. Specifically, the identification information for identifying information (record) is stored in #711. The task ID 711 stores an identification ID of a recovery task. The monitoring task ID 713 stores an identification ID of the monitoring task. The status 714 stores information indicating whether or not recovery has succeeded. The target 715 stores identification information of a volume to be backed up. The recovery layer 716 stores a storage layer in which the backup relationship is recovered. The switching source 717 stores identification information of a storage device of a switching source. The switching destination 718 stores identification information of a storage device of a switching destination.

### Overview

### <Backup Configuration>

An overview of the present invention will be described. In the backup system, the second storage device 220 to the fifth storage device 250 in which the backup data is arranged (stored) are set (registered, classified) as storage devices belonging to any storage layer of the primary layer or the secondary layer. Typically, the storage device belonging to the primary layer and the storage device belonging to the secondary layer are set (registered, classified) such that storage devices at sites different from each other belong to the primary layer and the secondary layer. Note that the storage device belonging to the primary layer and the storage device belonging to the secondary layer may be set (registered, classified) such that the storage devices at the same site belong to the primary layer and the secondary layer. The storage devices at different sites may be set (registered, classified) to belong to the same storage layer.

The backup system prepares a plurality of copies of backup data for backup target data, arranges the plurality of copies of backup data in a storage device in compliance with an arrangement rule, and manages the backup data in different storage devices. The arrangement rule is a rule that the primary backup data is arranged in the storage device of the primary layer and the secondary backup data is arranged in the storage device of the secondary layer. The backup system arranges the backup data in compliance with such an arrangement rule, and performs a backup operation so that the backup data maintains in the state of compliance with the arrangement rule, thereby realizing the backup operation with robustness and high availability.

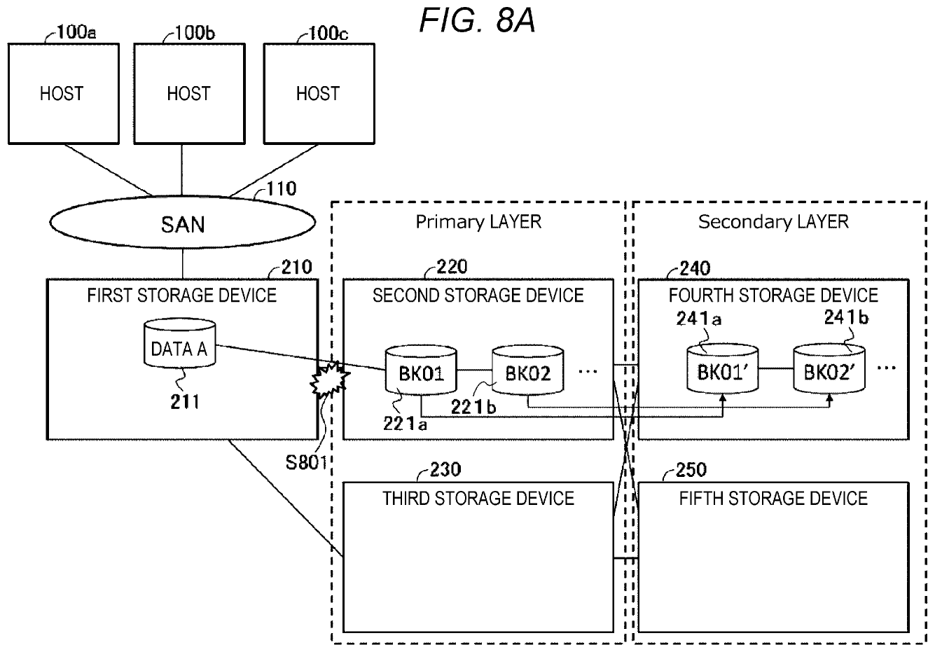

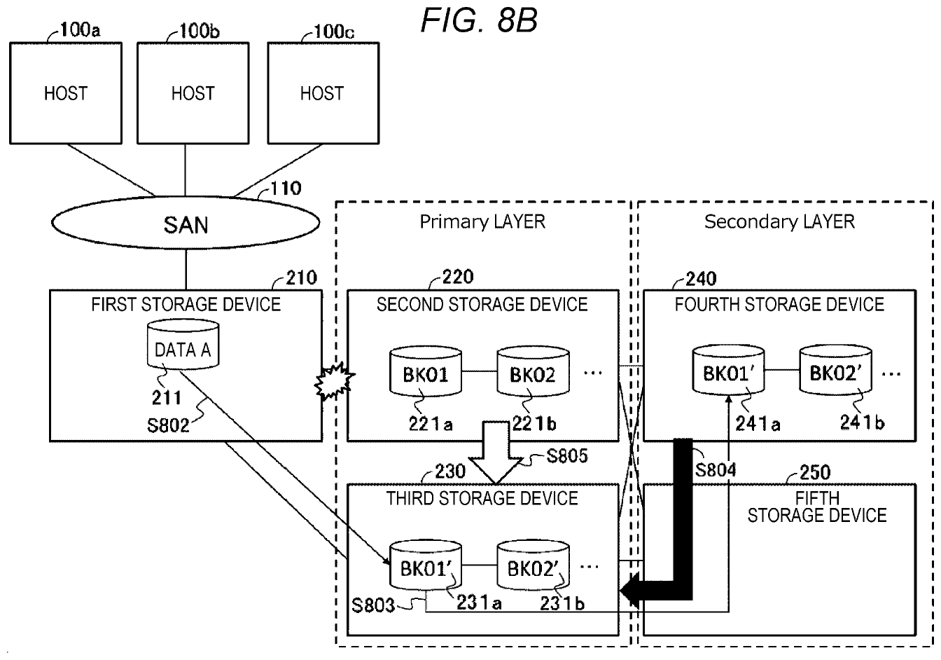

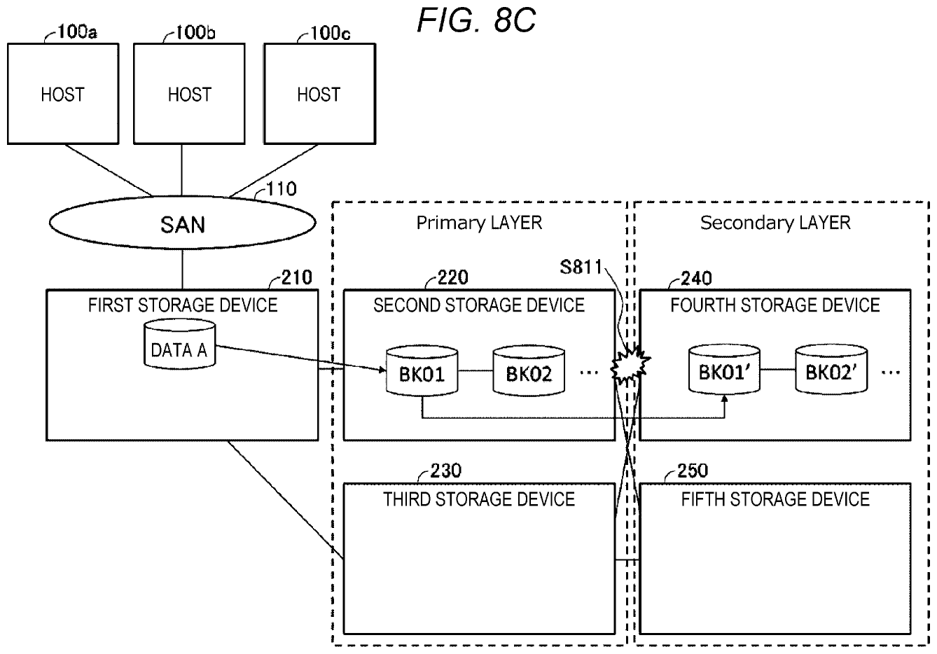

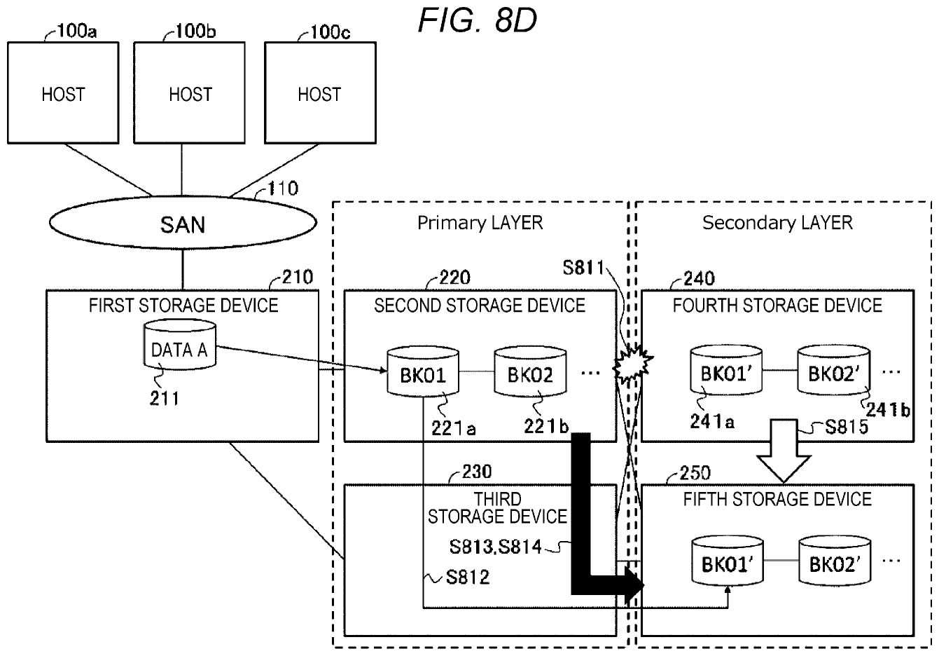

In the example illustrated in FIG. 8A, original data A to be backed up is arranged in the first storage device 210. The backup system arranges (stores) backup data BK01 and BK02 of the original data A (hereinafter, may be referred to as “primary backup data BK”) in the second storage device 220 of the primary layer, and arranges (stores) backup data BK01′ and BK02′ of the primary backup data BK of the original data A (hereinafter, may be referred to as “secondary backup data BK”) in the fourth storage device 240 of the secondary layer.

Note that, in this example, the backup executed by the first storage device 210 is performed by a full backup in which a copy of the data A stored in the business volume 211 is transmitted to the storage device of the primary layer of a backup destination and a differential backup in which a copy of data changed and added from and to first backup data is transmitted to the backup destination. The backup data BK01 is full backup data of the business volume 211, and the backup data BK02 is differential backup data of the business volume 211.

The backup executed by the second storage device 220 is performed by full backup in which a copy of each of the backup data BK01 and the backup data BK02 is transmitted to the backup destination. The backup data BK01′ and the backup data BK02′ are full backup data of the backup data BK01 and the backup data BK02, respectively.

In the backup system, the original data A, the primary backup data BK of the second storage device 220 of the primary layer, and the secondary backup data BK′ of the fourth storage device 240 of the secondary layer are in a relationship of being arranged in storage devices belonging to three different layers (1:1:1 relationship), whereby the backup operation with high availability can be realized. The backup system duplicates and manages the same backup data for each storage layer, thereby avoiding a risk of a data loss due to a device failure or the like and a risk of a backup data loss due to a security risk such as a virus.

The primary backup data BK of the data A of the business volume 211 is stored in the volume 221a (221b) of the second storage device 220 belonging to the primary layer by the first storage device 210. The primary backup data BK stored in the second storage device 220 belonging to the primary layer is backup data for the purpose of protecting the data A stored in the business volume 211 to be backed up.

The secondary backup data BK′ that is the backup data of the primary backup data BK of the volume 221a (221b) is stored in the volume 241a (241b) of the fourth storage device 240 belonging to the secondary layer by the second storage device 220 belonging to the primary layer. The secondary backup data BK′ stored in the fourth storage device 240 belonging to the secondary layer is backup data for the purpose of protecting the primary backup data BK.

The first storage device 210 including the business volume 211 transmits the primary backup data BK of the backup target data A to the second storage device 220 belonging to the primary layer and stores the data in the volume 221a (221b).

The second storage device 220 transmits the secondary backup data BK′, which is the backup data of the primary backup data BK, to the fourth storage device 240 belonging to the secondary layer and stores the data in the volume 241a (241b).

In this manner, the first storage device 210 stores the primary backup data BK in the second storage device 220, and the second storage device 220 stores the secondary backup data BK′ in the fourth storage device 240. Accordingly, since one storage device does not perform scheduled backup (data copy) of original data to a plurality of devices, a possibility that an IO load of the backup system increases can be reduced. Furthermore, the backup system can avoid a 1: N backup operation by minimizing access to the original data to minimize the load. That is, since storage devices forming the backup relationship can perform the backup operation only by accessing one storage device, it is possible to avoid the 1:N backup operation in which one storage device accesses a plurality of storage devices.

### <Monitoring Process, Recovery Process>

In the operation of the backup system, a failure of the storage device or a connection failure between the storage devices may cause a state where the arrangement rule of the backup data cannot be maintained in which, for the backup target data in the storage device, the primary backup data is arranged in the storage device of the primary layer and the secondary backup data is arranged in the storage device of the secondary layer.

In this regard, the backup system monitors whether or not the arrangement rule of the backup data can be maintained. In a case where a state occurs in which the arrangement rule of the backup data cannot be maintained, the backup system switches the storage device in which the backup data is arranged such that the arrangement rule of the backup data can be maintained, and restores the backup data such that the backup data is arranged in the storage device of a switching destination.

Specific examples will be described below.

For the backup target data A in the first storage device 210, the backup system illustrated in FIG. 8A arranges the primary backup data BK in the second storage device 220 of the primary layer and arranges the secondary backup data BK′ in the fourth storage device 240 of the secondary layer.

In the backup system, the first storage device 210 monitors a connection state between the first storage device 210 and the second storage device 220, and monitors a connection state between the second storage device 220 and the fourth storage device 240.

S801 (FIG. 8A): A connection failure occurs between the first storage device 210 and the second storage device 220.

S802 (FIG. 8B): The first storage device 210 selects the third storage device 230 that can be used instead of the second storage device 220 from among storage devices belonging to the primary layer.

S803 (FIG. 8B): The third storage device 230 selects the fourth storage device 240 capable of restoring the primary backup data BK to the third storage device 230 from among storage devices of the secondary layer.

S804 (FIG. 8B): The fourth storage device 240 transmits a copy of the secondary backup data BK′ to the third storage device 230, and restores the primary backup data BK to the third storage device 230.

S805 (FIG. 8B): The second storage device 220 is completely switched to the third storage device 230. Thereafter, for the backup target data A of the first storage device 210 of the original layer, the backup system arranges the primary backup data BK in the third storage device 230 of the primary layer and arranges the secondary backup data BK′ in the fourth storage device 240 of the secondary layer, thereby backing up the data A in the state of compliance with the arrangement rule.

In the backup system illustrated in FIG. 8C, for the backup target data A in the first storage device 210, the primary backup data BK is arranged in the second storage device 220 of the primary layer, and the secondary backup data BK′ is arranged in the fourth storage device 240 of the secondary layer.

In the backup system, the first storage device 210 monitors a connection state between the first storage device 210 and the second storage device 220, and monitors a connection state between the second storage device 220 and the fourth storage device 240.

S811 (FIG. 8C): A connection failure occurs between the second storage device 220 and the fourth storage device 240.

S812 (FIG. 8D): The second storage device 220 selects the fifth storage device 250 that can be used instead of the fourth storage device 240 from among the storage devices belonging to the secondary layer.

S813 (FIG. 8D): The fifth storage device 250 selects the second storage device 220 capable of restoring the primary backup data BK to the fifth storage device 250 from among the storage devices of the primary layer.

S814 (FIG. 8D): The second storage device 220 transmits a copy of the primary backup data BK to the fifth storage device 250, and restores the secondary backup data BK′ to the fifth storage device 250.

S815 (FIG. 8D): The fourth storage device 240 is completely switched to the fifth storage device 250. For the backup target data A of the first storage device 210, the backup system arranges the primary backup data BK in the second storage device 220 of the primary layer and arranges the secondary backup data BK′ in the fifth storage device 250 of the secondary layer, thereby backing up the data A in the state of compliance with the arrangement rule.

As described above, the backup system monitors whether or not the storage device is in the state of compliance with the arrangement rule of the backup data, and in a case where the state of compliance with the arrangement rule of the backup data cannot be maintained due to the connection failure of the storage device or the like, the backup system switches the storage device in which the backup data is arranged such that the state of compliance with the arrangement rule of the backup data can be maintained, and restores the backup data such that the backup data is arranged in the storage device of the switching destination.

Accordingly, the backup system can realize the backup operation with high availability by maintaining the relationship in which the backup target data and the backup data are arranged in storage devices belonging to three different layers (1:1:1 relationship).

### <Specific Operation>

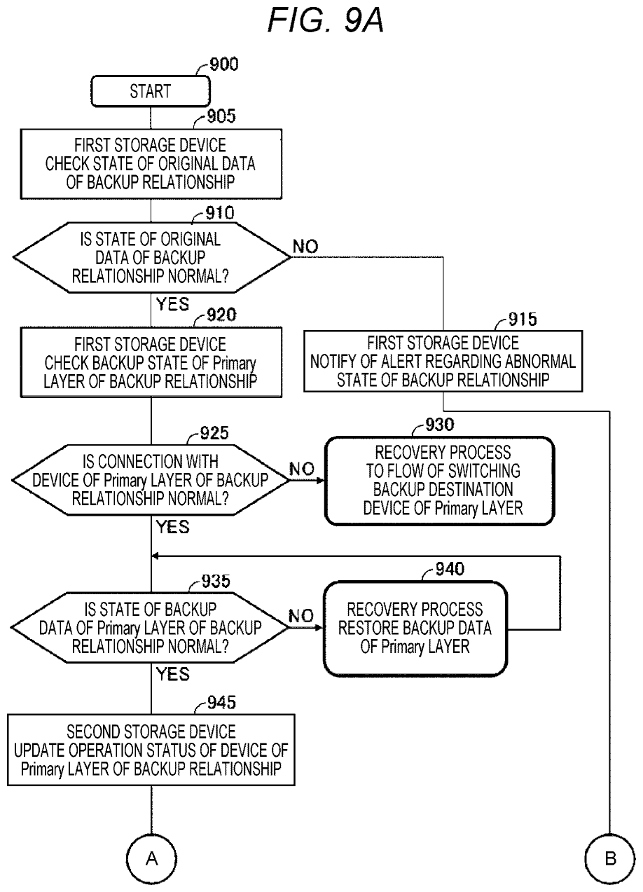

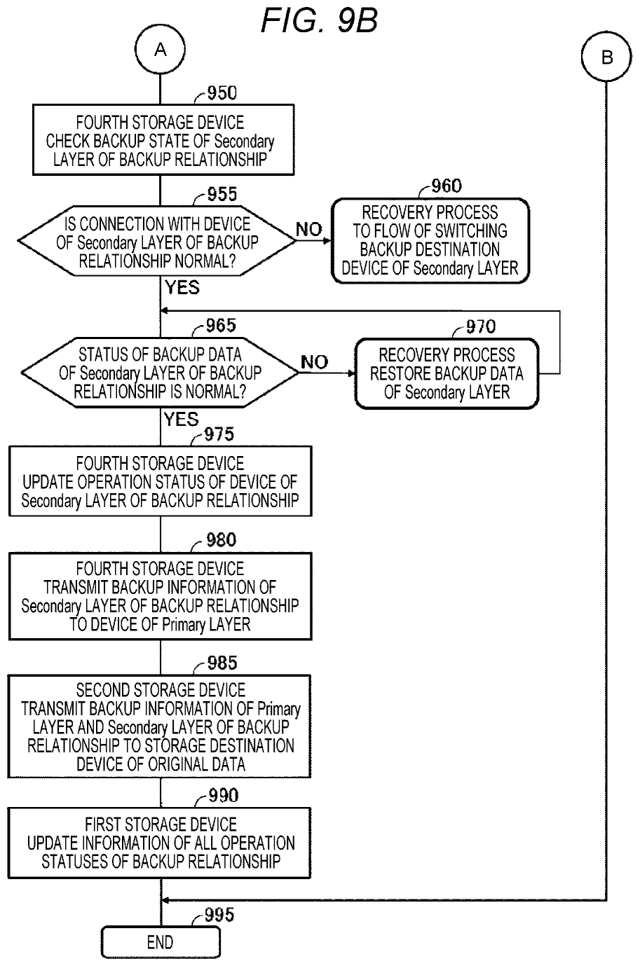

FIGS. 9A and 9B are flowcharts illustrating a processing flow of monitoring executed by the backup system. The backup system starts processing from step 900 in FIG. 9A and proceeds to step 905.

Step 905: The first storage device 210 checks the state of the original data (in this example, the original data A) of the first storage device 210 forming the backup relationship.

Step 910: The first storage device 210 determines whether or not the state of the original data is normal. In a case where the state of the original data is not normal, the first storage device 210 determines “NO” and proceeds to step 915. In a case where the state of the original data is normal, the first storage device 210 determines “YES” and proceeds to step 920.

Step 915: The first storage device 210 notifies another device (for example, the host 100 or the like) of an alert regarding an abnormal state of the backup relationship of the target data A (original data A).

Step 920: The first storage device 210 refers to the BK location table 6000 in FIG. 6 and the storage layer table 7000 in FIG. 7A, and checks a backup state (information regarding the storage device of the primary layer, the storage device of the secondary layer, and the backup data) of the storage device of the primary layer forming the backup relationship.

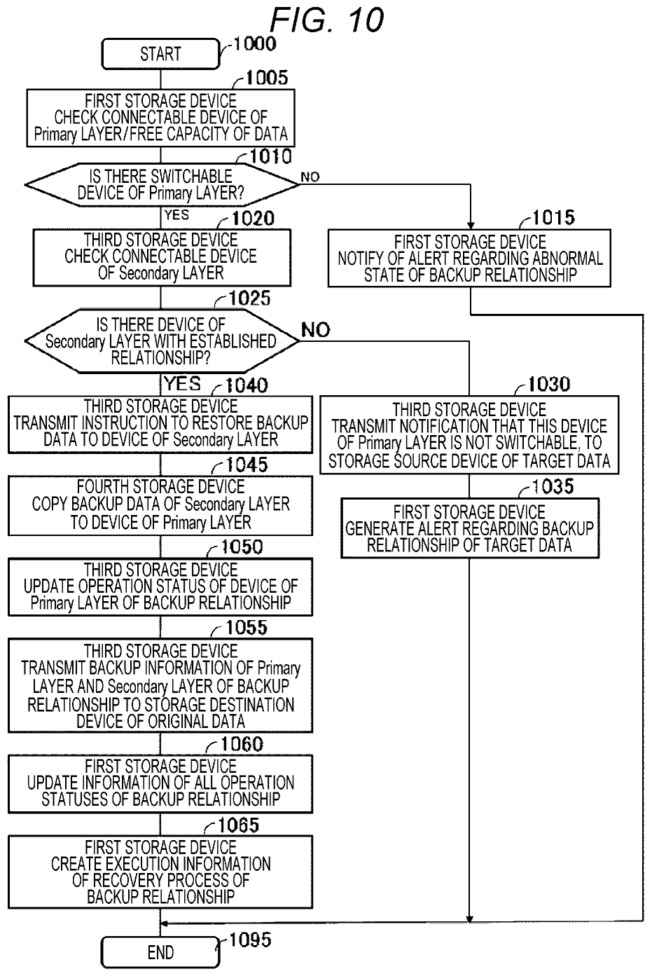

Step 925: The first storage device 210 determines whether or not a connection with the storage device belonging to the primary layer and forming the backup relationship is normal, on the basis of the status of the storage layer table 7000 in FIG. 7A. In this example, the first storage device 210 determines whether or not the connection with the second storage device 220 which belongs to the primary layer and stores the primary backup data BK of the original data A is normal. In a case where the connection is not normal, the first storage device 210 determines “NO”, proceeds to step 930, and proceeds to a recovery process (a flow of switching the backup destination device of the primary layer in FIG. 10 described later). In a case where the connection is normal, the first storage device 210 determines “YES” and proceeds to step 935.

Step 935: The first storage device 210 refers to the BK location table 6000 of FIG. 6 and determines whether or not the state of the primary backup data BK is normal. In a case where the state of the primary backup data BK is not normal, the first storage device 210 determines “NO” and proceeds to step 940, and the second storage device 220 restores the primary backup data BK. In step 940, the second storage device 220 belonging to the primary layer acquires the secondary backup data BK′ corresponding to the abnormal primary backup data BK from the fourth storage device 240 belonging to the secondary layer, and restores the primary backup data BK from the secondary backup data BK′. Note that in a case where the primary backup data BK is restored, the second storage device 220 belonging to the primary layer transmits update information to the first storage device 210, and the first storage device 210 changes the status corresponding to the restored primary backup data BK to “normal” in the BK location table 6000 of FIG. 6. Thereafter, the second storage device 220 belonging to the primary layer returns to step 935. In a case where the state of the primary backup data BK is normal, the first storage device 210 determines “YES” and proceeds to step 945.

Step 945: The second storage device 220 belonging to the primary layer updates an operation status (the information regarding the storage device of the primary layer, the storage device of the secondary layer, and the backup data) of the storage device of the primary layer in the backup relationship, and proceeds to step 950 in FIG. 9B.

Step 950: The first storage device 210 refers to the BK location table 6000 of FIG. 6 and the storage layer table 7000 of FIG. 7A, and checks the backup state (the information regarding the storage device of the primary layer, the storage device of the secondary layer, and the backup data) of the storage device (the fourth storage device 240 in this example) of the secondary layer forming the backup relationship.

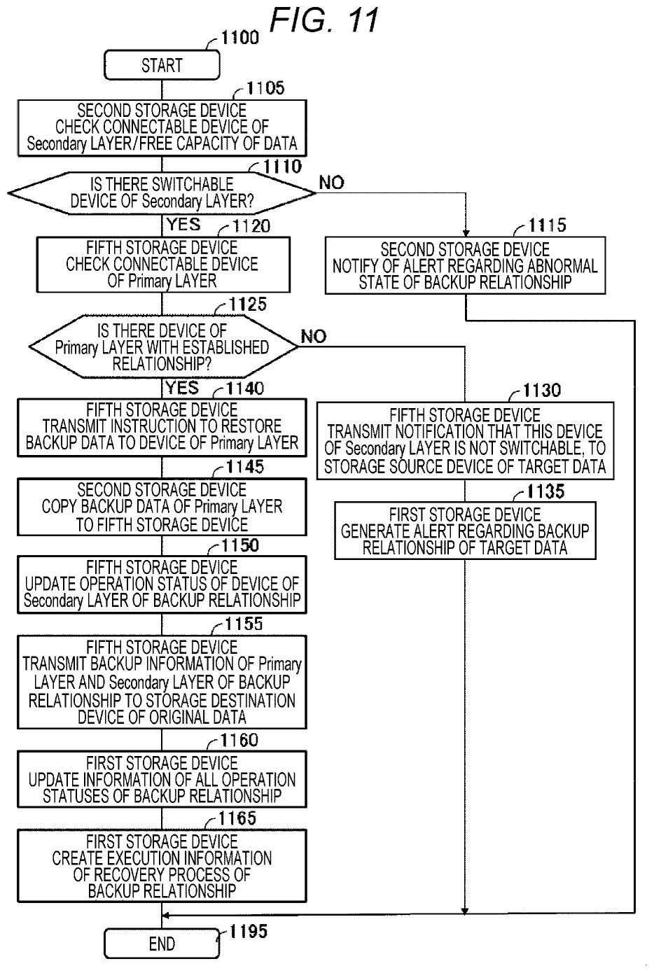

Step 955: The first storage device 210 determines whether or not a connection between the storage device belonging to the primary layer and the storage device belonging to the secondary layer and forming the backup relationship is normal, on the basis of the status of the storage layer table 7000 in FIG. 7A. In this example, the first storage device 210 determines whether or not the connection between the second storage device 220, which belongs to the primary layer and stores the primary backup data BK of the original data A, and the fourth storage device 240, which belongs to the secondary layer and stores the secondary backup data BK′, is normal. In a case where the connection is not normal, the first storage device 210 determines “NO”, proceeds to step 960, and proceeds to a recovery process (a flow of switching the backup destination device of the secondary layer in FIG. 11 described later). In a case where the connection is normal, the first storage device 210 determines “YES” and proceeds to step 965.

Step 965: The first storage device 210 refers to the BK location table 6000 of FIG. 6 and determines whether or not the state of the secondary backup data BK′ is normal. In a case where the state of the secondary backup data BK′ is not normal, the first storage device 210 determines “NO” and proceeds to step 970, and the fourth storage device 240 belonging to the secondary layer restores the secondary backup data BK′. In step 970, the fourth storage device 240 belonging to the secondary layer acquires the primary backup data BK corresponding to the abnormal secondary backup data BK′ from the second storage device 220 belonging to the primary layer, and restores the secondary backup data BK′ from the primary backup data BK. Note that in a case where the secondary backup data BK′ is restored, the fourth storage device 240 belonging to the secondary layer transmits update information to the first storage device 210, and the first storage device 210 changes the status corresponding to the restored secondary backup data BK′ to “normal” in the BK location table 6000 of FIG. 6. Thereafter, the fourth storage device 240 belonging to the secondary layer returns to step 965. In a case where the state of the secondary backup data BK′ is normal, the first storage device 210 determines “YES” and proceeds to step 975.

Step 975: The fourth storage device 240 belonging to the secondary layer updates an operation status (the information regarding the storage device of the primary layer, the storage device of the secondary layer, and the backup data) of the storage device of the secondary layer in the backup relationship.

Step 980: The fourth storage device 240 belonging to the secondary layer transmits, to the second storage device 220 belonging to the primary layer, the information regarding the backup data of the fourth storage device 240 belonging to the secondary layer and having the backup relationship.

Step 985: The second storage device 220 belonging to the primary layer transmits, to the first storage device 210, the information regarding the backup data of the storage device belonging to the primary layer and the information regarding the backup data of the storage device belonging to the secondary layer in the backup relationship.

Step 990: The first storage device 210 updates information (the information regarding the storage device of the primary layer, the storage device of the secondary layer, and the backup data) of all operation statuses of the backup relationship.

Step 995: The backup system temporarily ends this processing flow.

FIG. 10 is a flowchart illustrating a flow in which the backup system executes switching of the backup destination device of the primary layer. The backup system starts processing from step 1000 in FIG. 10 and proceeds to step 1005.

Step 1005: The first storage device 210 checks a connectable storage device belonging to the primary layer and a free capacity of data of the storage device belonging to the primary layer. Note that a storage device that is connectable to the first storage device 210 and has a free capacity capable of storing backup data is a switchable storage device.

Step 1010: The first storage device 210 determines whether or not there is a switchable storage device belonging to the primary layer. In a case where there is no switchable storage device belonging to the primary layer, the first storage device 210 determines “NO”, proceeds to step 1015, and notifies another device (for example, the host 100 or the like) of an alert regarding the backup relationship of the target data A (original data A). Thereafter, the first storage device 210 proceeds to step 1095 to temporarily end this processing flow.

In a case where there is the switchable storage device belonging to the primary layer, the first storage device 210 determines “YES” and proceeds to step 1020. Note that, in this example, the following processing will be described on the assumption that the third storage device 230 exists as the switchable storage device belonging to the primary layer.

Step 1020: The third storage device 230 checks a connectable storage device of the secondary layer.

Step 1025: The third storage device 230 determines whether or not there is a storage device of the secondary layer with an established relationship (after completion of backup setting for backing up data of the third storage device 230). In a case where there is no storage device of the secondary layer with an established relationship, the third storage device 230 determines “NO” and proceeds to step 1030. In a case where there is a storage device of the secondary layer with an established relationship, the third storage device 230 determines “YES” and proceeds to step 1040. Note that, in this example, the following processing will be described on the assumption that the fourth storage device 240 exists as the storage device belonging to the secondary layer with an established relationship.

Step 1030: The third storage device 230 transmits, to the first storage device 210 which is the storage source of the target data A, a notification that this third storage device 230 of the primary layer is not switchable.

Step 1035: The first storage device 210 generates an alert regarding the backup relationship of the target data A, and proceeds to step 1095.

Step 1040: The third storage device 230 transmits an instruction to restore backup data to the fourth storage device 240 of the secondary layer.

Step 1045: The fourth storage device 240 copies the secondary backup data BK′ of the secondary layer to the third storage device 230 of the primary layer, and the third storage device 230 restores the primary backup data BK from the copy of the secondary backup data BK′. Note that the restoration also includes using the copy as the primary backup data BK as it is.

Step 1050: The third storage device 230 updates an operation status (the information regarding the storage device of the primary layer, the storage device of the secondary layer, and the backup data) of the storage device of the primary layer in the backup relationship.

Step 1055: The third storage device 230 transmits, to the first storage device 210 of a storage destination of the original data A, the information regarding the backup data of the third storage device 230 belonging to the primary layer and having the backup relationship.

Step 1060: The first storage device 210 updates the information (the information regarding storage device of the primary layer, the storage device of the secondary layer, and the backup data) of all the operation statuses of the backup relationship, on the basis of the information received from the third storage device 230 of the primary layer.

Step 1065: The first storage device 210 creates execution information of the recovery process of the backup relationship and stores the execution information in the recovery task table 7100.

Step 1095: The backup system temporarily ends this processing flow.

FIG. 11 is a flowchart illustrating a flow in which the backup system executes switching of the backup destination device of the secondary layer. The backup system starts processing from step 1100 in FIG. 11 and proceeds to step 1105.

Step 1105: The second storage device 220 checks a connectable storage device belonging to the secondary layer and a free capacity of data of the storage device belonging to the secondary layer. Note that a storage device that is connectable to the second storage device 220 and has a free capacity capable of storing backup data is a switchable storage device.

Step 1110: The second storage device 220 determines whether or not there is a switchable storage device belonging to the secondary layer. In a case where there is no switchable storage device belonging to the secondary layer, the second storage device 220 determines “NO”, proceeds to step 1115, and notifies another device (for example, the host 100 or the like) of an alert regarding the backup relationship of the target data A. Thereafter, the second storage device 220 proceeds to step 1195 to temporarily end this processing flow.

In a case where there is the switchable storage device belonging to the secondary layer, the second storage device 220 determines “YES” and proceeds to step 1120. Note that, in this example, the following processing will be described on the assumption that the fifth storage device 250 exists as the switchable storage device belonging to the secondary layer.

Step 1120: The fifth storage device 250 checks a connectable storage device of the primary layer.

Step 1125: The fifth storage device 250 determines whether or not there is a storage device of the primary layer with an established relationship (after completion of backup setting for backing up data to the fifth storage device 250). In a case where there is no storage device of the primary layer with an established relationship, the fifth storage device 250 determines “NO” and proceeds to step 1130. In a case where there is a storage device of the primary layer with an established relationship, the fifth storage device 250 determines “YES” and proceeds to step 1140. Note that, in this example, the following processing will be described on the assumption that the second storage device 220 exists as the storage device belonging to the primary layer with an established relationship.

Step 1130: The fifth storage device 250 transmits, to the first storage device 210 which is the storage source of the target data A, a notification that this fifth storage device 250 of the secondary layer is not switchable.

Step 1135: The first storage device 210 generates an alert regarding the backup relationship of the target data A, and proceeds to step 1195.

Step 1140: The fifth storage device 250 transmits an instruction to restore backup data to the second storage device 220 of the primary layer.

Step 1145: The second storage device 220 copies the primary backup data BK of the primary layer to the fifth storage device 250 of the secondary layer, and the fifth storage device 250 restores the secondary backup data BK′ from the copy of the primary backup data BK. Note that the restoration also includes using the copy as the secondary backup data BK′ as it is.

Step 1150: The fifth storage device 250 updates an operation status (the information regarding the storage device of the primary layer, the storage device of the secondary layer, and the backup data) of the storage device of the secondary layer in the backup relationship.

Step 1155: The fifth storage device 250 transmits, to the first storage device 210 of the storage destination of the original data A, the information regarding the backup data of the fifth storage device 250 belonging to the secondary layer and having the backup relationship.

Step 1160: The first storage device 210 updates the information (the information regarding storage device of the primary layer, the storage device of the secondary layer, and the backup data) on all the operation statuses of the backup relationship, on the basis of the information received from the fifth storage device 250 of the secondary layer.

Step 1165: The first storage device 210 creates execution information of the recovery process of the backup relationship and stores the execution information in the recovery task table 7100.

Step 1195: The backup system temporarily ends this processing flow.

### Effects

As described above, the backup system according to the first embodiment of the present invention can realize the backup operation with robustness and high availability by maintaining the relationship in which the backup target data and the backup data are arranged in storage devices belonging to three different layers (1:1:1 relationship).

### Second Embodiment

A backup system according to a second embodiment of the present invention will be described. The backup system according to the second embodiment of the present invention is different from the backup system according to the first embodiment only in the following points.

In a case where it becomes necessary to switch the storage device forming the backup relationship due to a state where it is unable to comply with the arrangement rule of the backup data, the backup system according to the second embodiment calculates an operation score for evaluating an operation state of the storage device, selects a storage device having a superior operation score on the basis of the operation score, and switches to the selected storage device. Accordingly, the backup system can efficiently perform the backup operation.

Hereinafter, this difference will be mainly described.

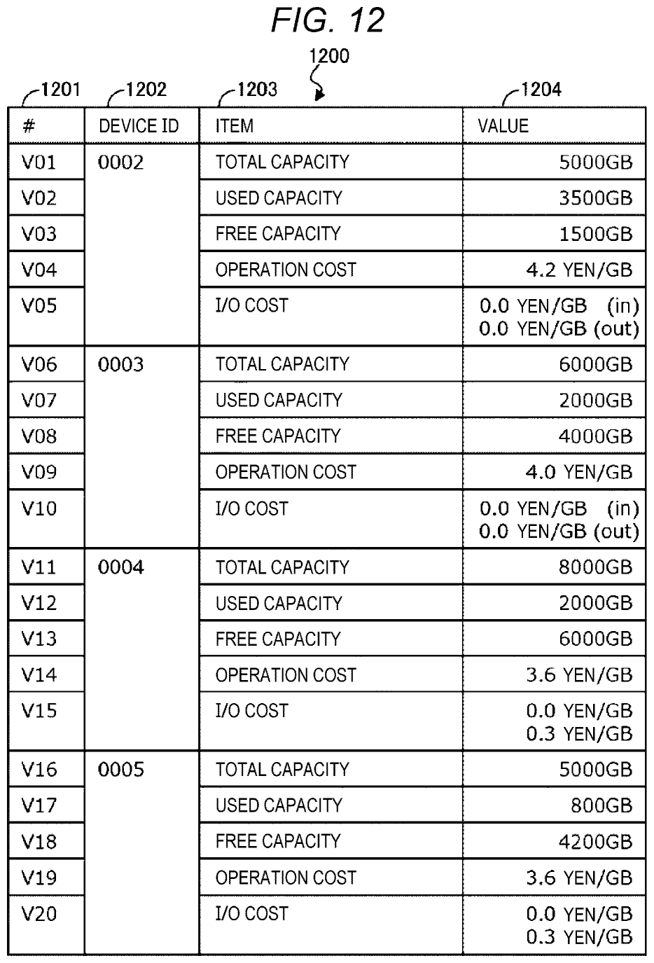

FIG. 12 is a diagram for describing an evaluation score table 1200. The evaluation score table 1200 is stored in the first storage device 210. As illustrated in FIG. 12, the evaluation score table 1200 includes #1201, a device ID 1202, an item 1203, and a value 1204 as columns for storing information (values). In the evaluation score table 1200, information corresponding to columns necessary for calculating the operation score of the storage device is stored as information (record) in units of rows in association with each other. Specifically, in #1201, identification information allocated to the information (record) in units of rows is stored. The device ID 1202 stores an ID of the storage device. The item 1203 stores an item of information for calculating an evaluation score. The value 1204 stores a value of the corresponding item.

Note that the backup system calculates the operation score on the basis of the evaluation score table 1200 and the backup table 5000 by operation score frc(s)=(predicted consumption capacity score)×w1 (priority weight)+ (total operation cost)×w2 (priority weight). In the calculation formula, the predicted consumption capacity score is calculated by predicted consumption capacity score={(full backup capacity+differential backup capacity)}×capacity reduction rate (%), and is calculated by total operation cost (yen/month)=assumed capacity cost+assumed I/O cost. A smaller operation score is evaluated as superior.

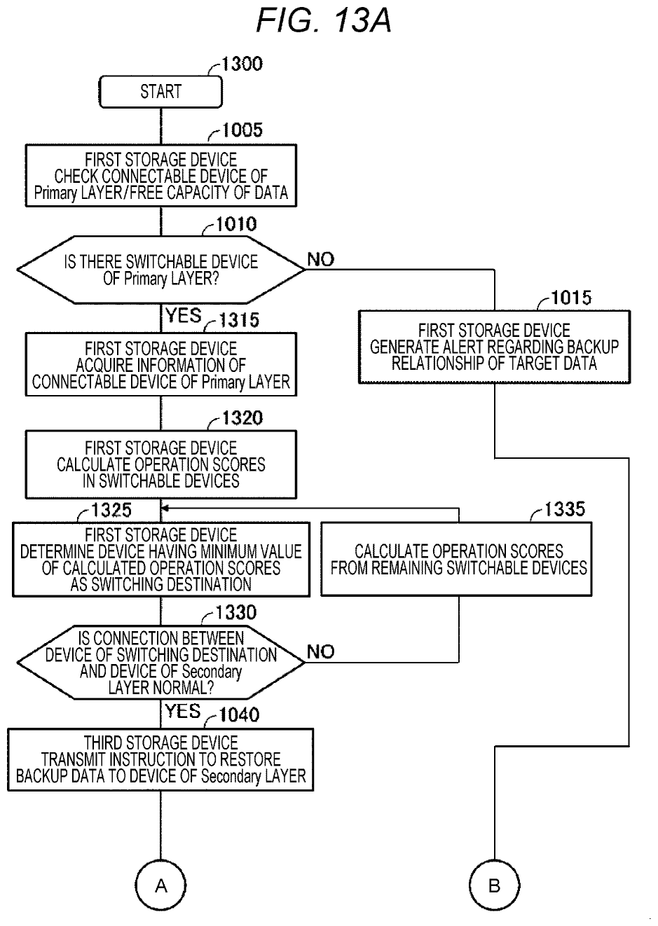

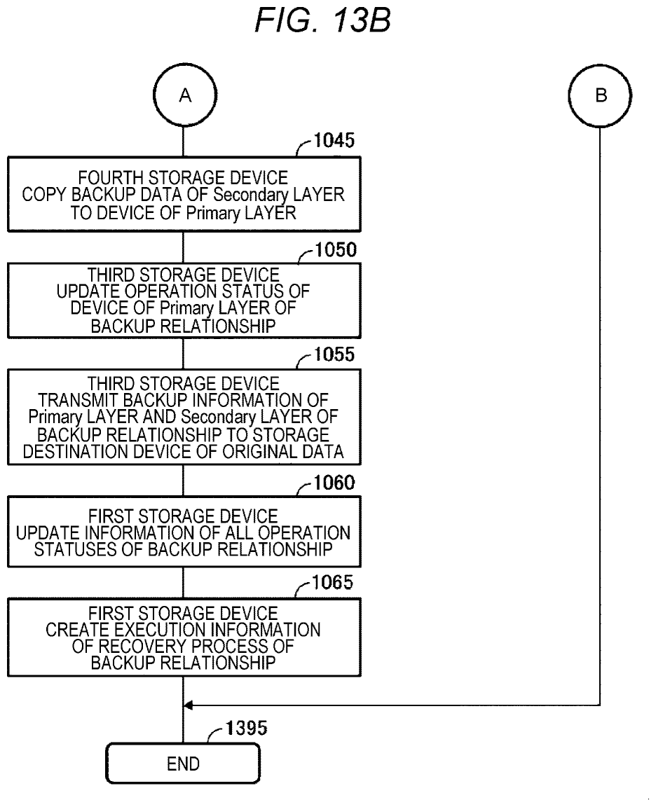

FIGS. 13A and 13B are flowcharts illustrating a flow in which the backup system according to the second embodiment executes primary layer device switching processing. The flowcharts of FIGS. 13A and 13B are different from the flowchart of FIG. 10 only in that steps 1020 to 1035 of the flowchart of FIG. 10 are deleted and steps 1315 to 1335 are added between steps 1010 and 1040. Therefore, this difference will be mainly described below.

In the second embodiment, the backup system includes a plurality of other storage devices other than the first storage device 210 to the fifth storage device 250. A plurality of other storage devices other than the second storage device 220 and the third storage device 230 belong to the primary layer. A plurality of other storage devices other than the fourth storage device 240 and the fifth storage device 250 belong to the secondary layer.

In a case where there is the switchable storage device belonging to the primary layer in step 1010, the first storage device 210 determines “YES” and proceeds to step 1315. Note that, in this example, there are a plurality of storage devices including the third storage device 230 as the switchable storage devices belonging to the primary layer.

Step 1315: The first storage device 210 acquires information of the connectable (switchable) storage device belonging to the primary layer from the evaluation score table 1200 and the backup table 5000.

Step 1320: The first storage device 210 calculates an operation score in the switchable storage device on the basis of the information of the storage device acquired in step 1315.

Step 1325: The first storage device 210 determines, as the switching destination, a storage device having a minimum value of the calculated operation scores from among the plurality of storage devices belonging to the primary layer.

Step 1330: The first storage device 210 determines whether or not a connection state between the storage device of the switching destination and the storage device belonging to the secondary layer is normal.

In a case where the connection state between the storage device of the switching destination and the storage device belonging to the secondary layer is not normal, the first storage device 210 determines “NO” in step 1330 and proceeds to step 1335. In a case where the connection state between the storage device of the switching destination and the storage device belonging to the secondary layer is normal, the first storage device 210 determines “YES” in step 1330 and proceeds to step 1040 described above. Note that, in this example, the following processing will be described on the assumption that the third storage device 230 is selected as the switchable storage device belonging to the primary layer and having the smallest (superior) operation score. Thereafter, the backup system executes the processing of steps 1040 to 1065 described above, and then proceeds to step 1395 to temporarily end this processing flow.

Step 1335: The first storage device 210 calculates operation scores from remaining switchable storage devices other than the switching destination storage device determined in step 1325, proceeds to step 1325 again, and determines, as the switching destination, a storage device having the minimum value of the calculated operation scores from among the remaining switchable storage devices. Thereafter, the storage device proceeds to step 1330 and executes the processing of step 1330 described above.

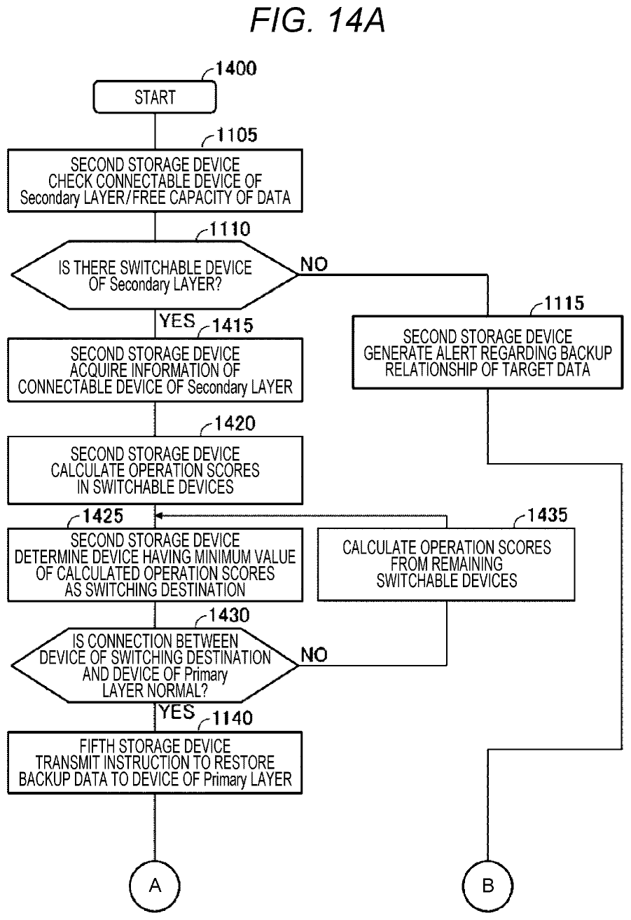

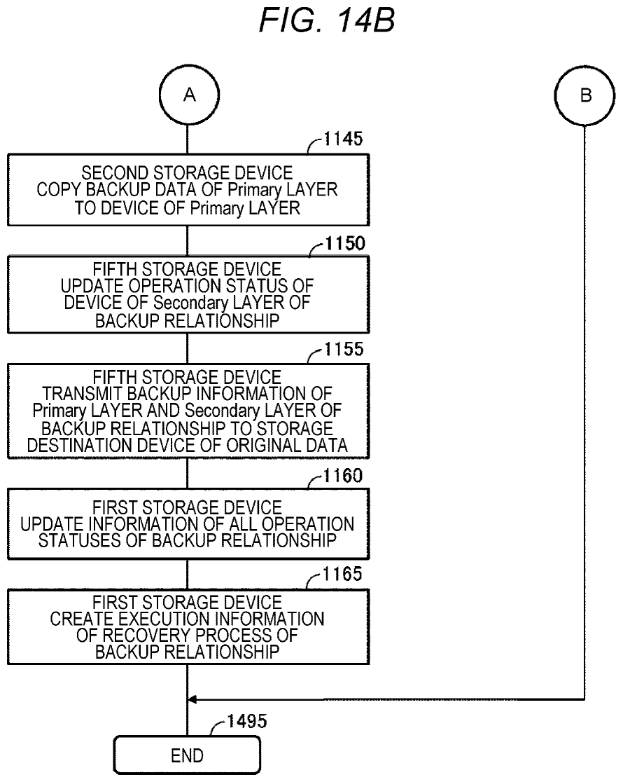

FIGS. 14A and 14B are flowcharts illustrating a flow in which the backup system according to the second embodiment executes secondary layer device switching processing. The flowcharts of FIGS. 14A and 14B are different from the flowchart of FIG. 11 only in that steps 1120 to 1135 of the flowchart of FIG. 11 are deleted and steps 1415 to 1435 are added between steps 1110 and 1140. Therefore, this difference will be mainly described below.

In a case where there is the switchable storage device belonging to the secondary layer in step 1110, the second storage device 220 determines “YES” and proceeds to step 1415. Note that, in this example, there are a plurality of storage devices including the fifth storage device 250 as the switchable storage device belonging to the secondary layer.

Step 1415: The second storage device 220 acquires information of the connectable (switchable) storage device belonging to the secondary layer from the evaluation score table 1200 and the backup table 5000.

Step 1420: The second storage device 220 calculates an operation score in the switchable storage device on the basis of the information of the storage device acquired in step 1415.

Step 1425: The second storage device 220 determines, as the switching destination, a storage device having a minimum value of the calculated operation scores from among the plurality of storage devices belonging to the secondary layer.

Step 1430: The second storage device 220 determines whether or not a connection state between the storage device of the switching destination and the storage device belonging to the primary layer is normal. In a case where the connection state between the storage device of the switching destination and the storage device belonging to the primary layer is not normal, the second storage device 220 determines “NO” in step 1430 and proceeds to step 1435. In a case where the connection state between the storage device of the switching destination and the storage device belonging to the primary layer is normal, the second storage device 220 determines “YES” in step 1430 and proceeds to step 1140 described above. Note that, in this example, the following processing will be described on the assumption that the fifth storage device 250 is selected as the switchable storage device belonging to the secondary layer and having the superior (smallest) operation score. Thereafter, the backup system executes the processing of steps 1140 to 1165 described above, and then proceeds to step 1495 to temporarily end this processing flow.

Step 1435: The second storage device 220 calculates operation scores from remaining switchable storage devices other than the switching destination storage device determined in step 1425, proceeds to step 1425 again, and determines, as the switching destination, a storage device having the minimum value of the calculated operation scores from among the remaining switchable storage devices. Thereafter, the second storage device 220 proceeds to step 1430 and executes the processing of step 1430 described above.

### Effects

As described above, the backup system according to the second embodiment of the present invention has the same effects as those of the first embodiment. Furthermore, the backup system according to the second embodiment of the present invention can efficiently perform the backup operation.

### Third Embodiment

A backup system according to a third embodiment of the present invention will be described. The backup system according to the third embodiment of the present invention is different from the backup system according to the first embodiment only in the following points.

In a case where the switching of the storage device of the primary layer and/or the switching of the storage device of the secondary layer are executed, the backup system according to the third embodiment monitors whether or not, at the time of executing the monitoring process, the storage device forming the backup relationship can be returned from the storage device after switching to the storage device before switching.

In practice, in a case where a path can be established with the device of the primary layer or the secondary layer due to reasons such as recovery of the device before switching or recovery of the connection, the monitoring process attempts to restore the storage device forming the backup relationship.

Hereinafter, this difference will be mainly described.

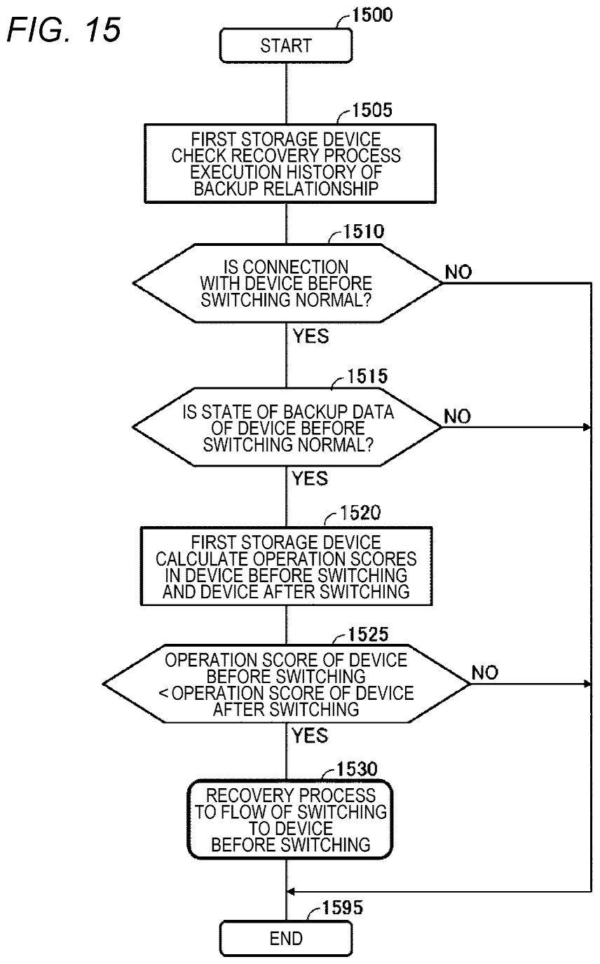

FIG. 15 is a flowchart illustrating a flow of processing executed by the backup system. The backup system starts the processing from step 1500 in FIG. 15 and proceeds to step 1505. Note that, in this example, an example will be described in which the storage device before switching is the second storage device 220 and the storage device after switching is the third storage device 230.

Step 1505: The first storage device 210 refers to the recovery task table 7100 of FIG. 7B and checks an execution history of the recovery process of the backup relationship.

Step 1510: The first storage device 210 determines whether or not the connection with the storage device before switching is normal. In a case where the connection with the storage device before switching is not normal, the first storage device 210 determines “NO” and proceeds to step 1595 to temporarily end this processing flow. In a case where the connection with the storage device before switching is normal, the first storage device 210 determines “YES” and proceeds to step 1515.

Step 1515: The first storage device 210 determines whether or not the state of the backup data of the storage device before switching is normal. In a case where the state of the backup data of the storage device before switching is not normal, the first storage device 210 determines “NO” and proceeds to step 1595 to temporarily end this processing flow. In a case where the state of the backup data of the storage device before switching is normal, the first storage device 210 determines “YES” and proceeds to step 1520.

Step 1520: The first storage device 210 calculates the operation scores of the storage device before switching and the storage device after switching on the basis of the evaluation score table 1200 and the backup table 5000.

Step 1525: The first storage device 210 determines whether or not the operation score of the storage device before switching is smaller than the operation score of the storage device after switching. In a case where the operation score of the storage device before switching is equal to or larger than the operation score of the storage device after switching, the first storage device 210 determines “NO” and proceeds to step 1595 to temporarily end this processing flow.

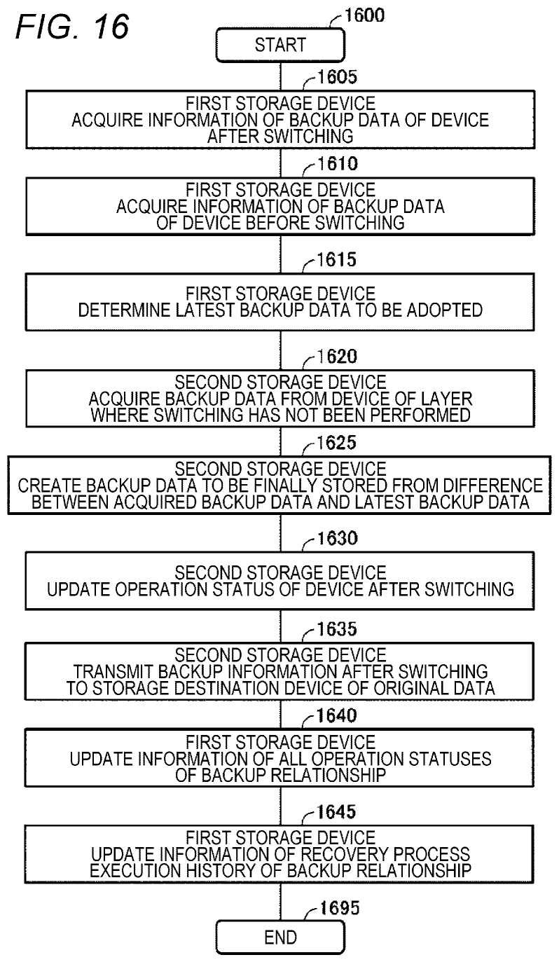

In a case where the operation score of the storage device before switching is smaller than the operation score of the storage device after switching, the first storage device 210 determines “YES”, proceeds to step 1530 to execute the recovery process of FIG. 16 (a flow of switching to the device before switching), and then proceeds to step 1595 to temporarily end this processing flow.

FIG. 16 is a flowchart illustrating the flow of switching to the device before switching. The backup system starts processing from step 1600, executes processing of steps 1605 to 1645 described below, and then proceeds to step 1695 to temporarily end this processing flow.

Step 1605: The first storage device 210 acquires information of the backup data of the storage device after switching.

Step 1610: The first storage device 210 acquires information of the backup data of the storage device before switching.

Step 1615: The first storage device 210 determines latest backup data to be adopted.

Step 1620: The second storage device 220 acquires backup data from the storage device of the secondary layer where switching has not been performed.

Step 1625: The second storage device 220 creates backup data to be finally stored, from a difference between the acquired backup data and the latest backup data.

Step 1630: The second storage device 220 updates the operation status of the second storage device 220 after switching (after returning to the device before switching).

Step 1635: The second storage device 220 transmits, to the device storing the original data (first storage device 210), backup information after switching (after returning to the device before switching).

Step 1640: The first storage device 210 updates information (the information regarding the storage device of the primary layer, the storage device of the secondary layer, and the backup data) of all operation statuses of the backup relationship.

Step 1645: The first storage device 210 creates execution information of the recovery process of the backup relationship and stores the execution information in the recovery task table 7100.

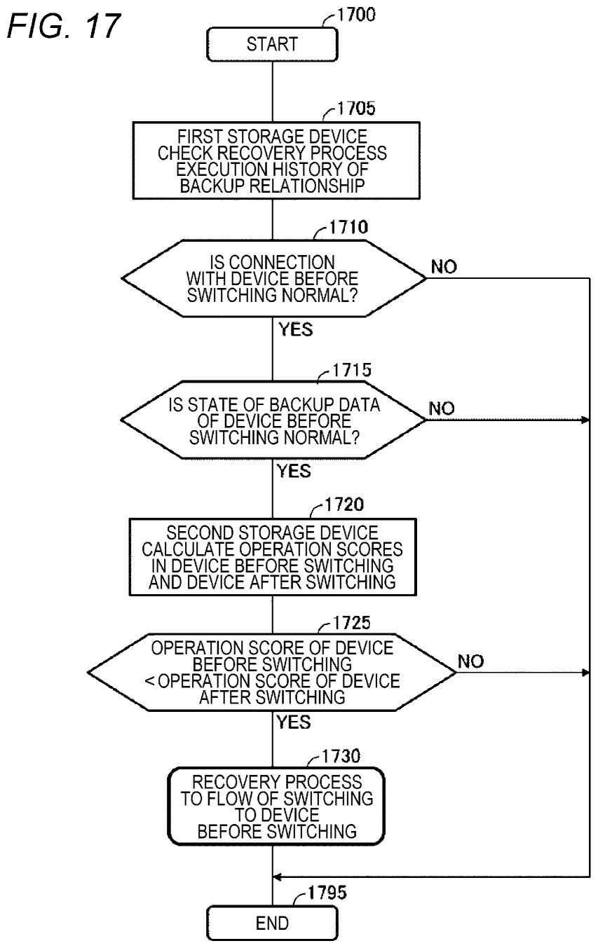

FIG. 17 is a flowchart illustrating a flow of processing executed by the backup system. The backup system starts the processing from step 1700 in FIG. 17 and proceeds to step 1705. Note that, in this example, an example will be described in which the storage device before switching is the fourth storage device 240 and the storage device after switching is the fifth storage device 250.

Step 1705: The first storage device 210 refers to the recovery task table 7100 of FIG. 7B and checks an execution history of the recovery process of the backup relationship.

Step 1710: The first storage device 210 determines whether or not a connection between the second storage device 220 and the storage device before switching is normal. In a case where the connection between the second storage device 220 and the storage device before switching is not normal, the first storage device 210 determines “NO” and proceeds to step 1795 to temporarily end this processing flow. In a case where the connection between the second storage device 220 and the storage device before switching is normal, the first storage device 210 determines “YES” and proceeds to step 1715.

Step 1715: The first storage device 210 determines whether or not the state of the backup data of the storage device before switching is normal. In a case where the state of the backup data of the storage device before switching is not normal, the first storage device 210 determines “NO” and proceeds to step 1795 to temporarily end this processing flow. In a case where the state of the backup data of the storage device before switching is normal, the first storage device 210 determines “YES” and proceeds to step 1720.

Step 1720: The second storage device 220 calculates the operation scores of the storage device before switching and the storage device after switching on the basis of the evaluation score table 1200 and the backup table 5000.

Step 1725: The second storage device 220 determines whether or not the operation score of the storage device before switching is smaller than the operation score of the storage device after switching. In a case where the operation score of the storage device before switching is equal to or larger than the operation score of the storage device after switching, the second storage device 220 determines “NO” and proceeds to step 1795 to temporarily end this processing flow.

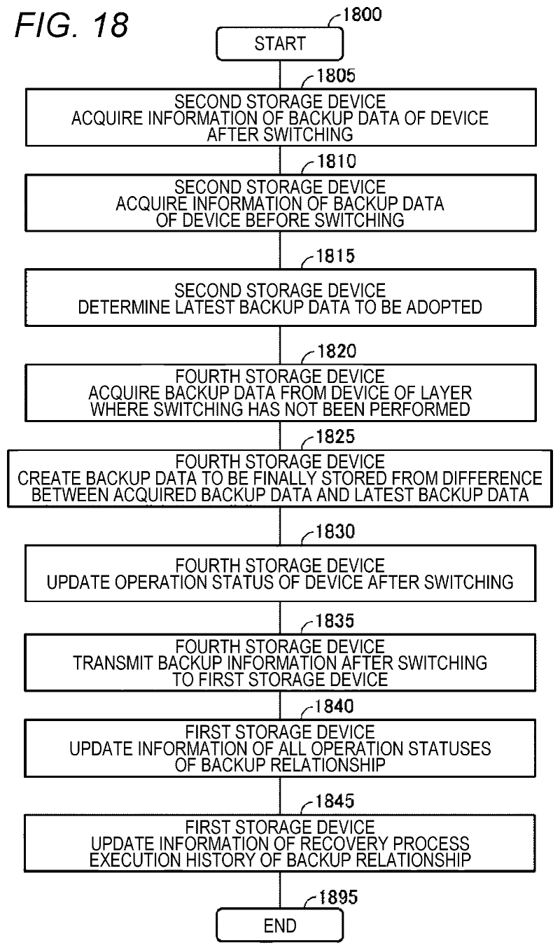

In a case where the operation score of the storage device before switching is smaller than the operation score of the storage device after switching, the second storage device 220 determines “YES”, proceeds to step 1730 to execute the recovery process of FIG. 18 (a flow of switching to the device before switching), and then proceeds to step 1795 to temporarily end this processing flow.

FIG. 18 is a flowchart illustrating the flow of switching to the device before switching. The backup system starts processing from step 1800, executes processing of steps 1805 to 1845 described below, and then proceeds to step 1895 to temporarily end this processing flow.

Step 1805: The second storage device 220 acquires information of the backup data of the storage device after switching.

Step 1810: The second storage device 220 acquires information of the backup data of the storage device before switching.

Step 1815: The second storage device 220 determines latest backup data to be adopted.

Step 1820: The fourth storage device 240 acquires backup data from the storage device of the primary layer where switching has not been performed.

Step 1825: The fourth storage device 240 creates backup data to be finally stored from a difference between the acquired backup data and the latest backup data.

Step 1830: The fourth storage device 240 updates the operation status of the fourth storage device 240 after switching (after returning to the device before switching).

Step 1835: The fourth storage device 240 transmits, to the first storage device 210, backup information after switching (after returning to the device before switching).

Step 1840: The first storage device 210 updates information (the information regarding the storage device of the primary layer, the storage device of the secondary layer, and the backup data) of all operation statuses of the backup relationship.

Step 1845: The first storage device 210 creates execution information of the recovery process of the backup relationship and stores the execution information in the recovery task table 7100.

### Effects

As described above, the backup system according to the third embodiment of the present invention has the same effects as those of the first embodiment. Furthermore, the backup system according to the third embodiment of the present invention can efficiently perform the backup operation by returning the storage device forming the backup relationship to the storage device before switching on the basis of the operation score.

### Fourth Embodiment

A backup system according to a fourth embodiment of the present invention will be described. The backup system according to the fourth embodiment of the present invention is different from the backup system according to the first embodiment only in the following points.

The backup system according to the fourth embodiment monitors the operation states of the storage device of the primary layer and the storage device of the secondary layer, and optimizes the storage devices (the storage device of the primary layer and the storage device of the secondary layer) forming the backup relationship.

Hereinafter, this difference will be mainly described.

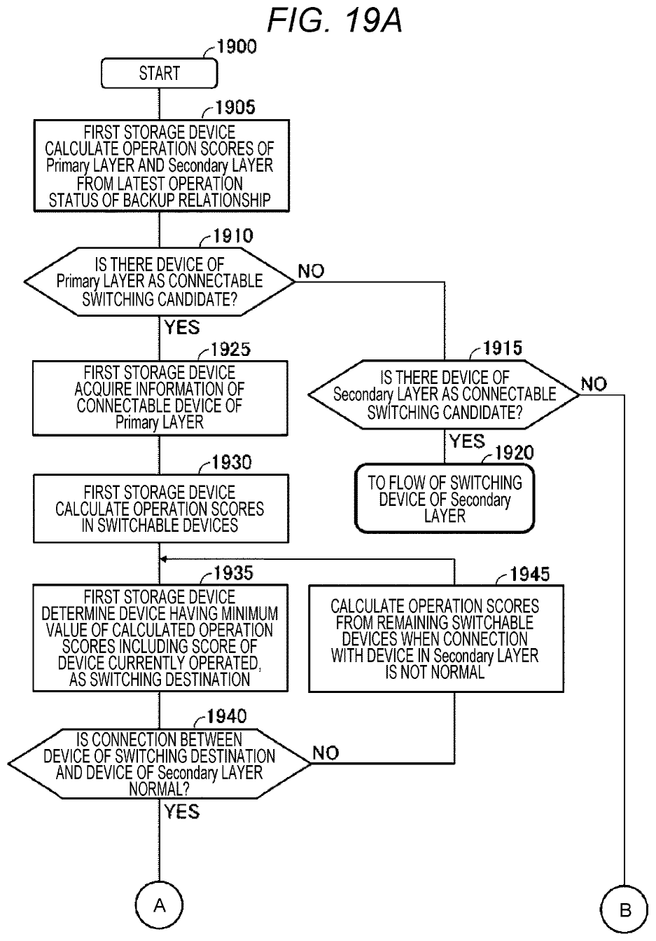

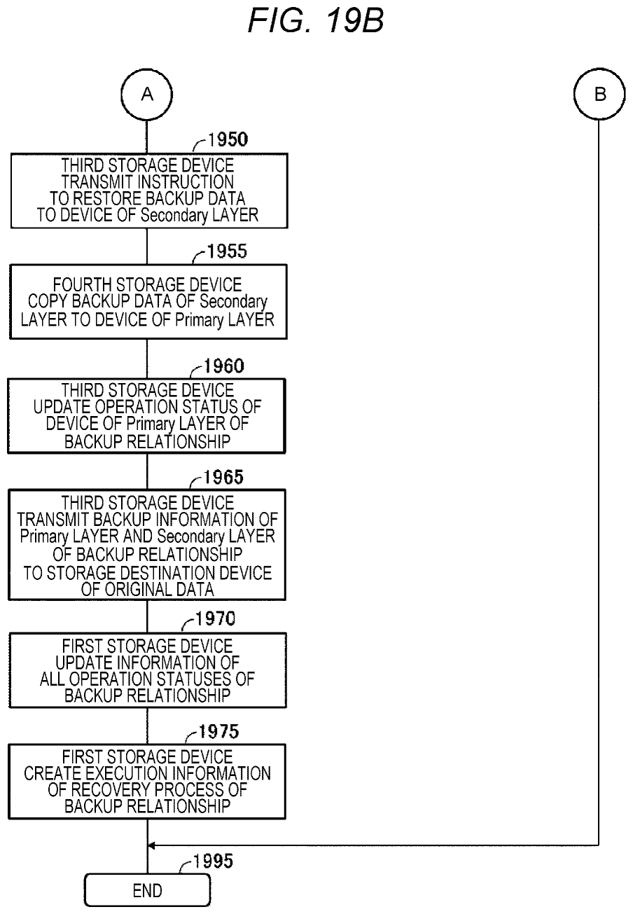

FIGS. 19A and 19B are flowcharts illustrating a flow of processing executed by the backup system. The backup system starts processing from step 1900 in FIG. 19A and proceeds to step 1905.

Step 1905: The first storage device 210 calculates the operation scores of the storage device belonging to the primary layer and the storage device belonging to the secondary layer from the latest operation status of the backup relationship.

Step 1910: The first storage device 210 determines whether or not there is a storage device belonging to the primary layer as a connectable switching candidate. In a case where there is no storage device belonging to the primary layer as a connectable switching candidate, the first storage device 210 determines “NO” and proceeds to step 1915. In a case where there is the storage device belonging to the primary layer as a connectable switching candidate, the first storage device 210 determines “YES” and proceeds to step 1725.

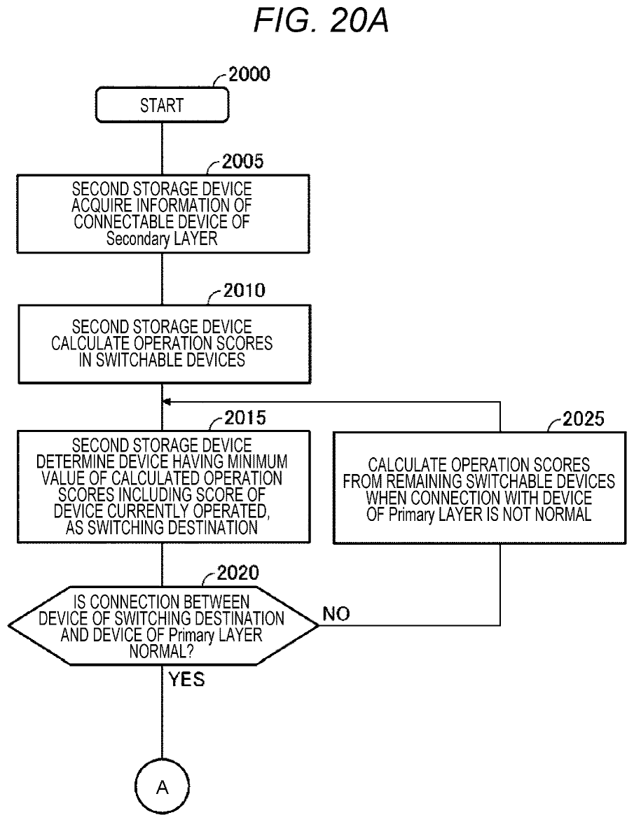

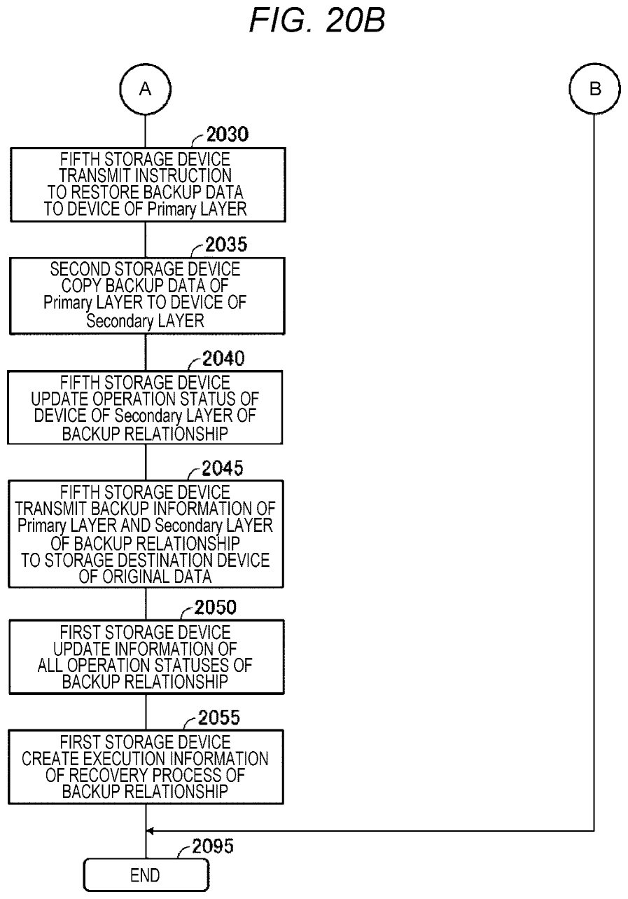

Step 1915: The second storage device 220 determines whether or not there is a storage device belonging to the secondary layer as a connectable switching candidate. In a case where there is no storage device belonging to the secondary layer as a connectable switching candidate, the second storage device 220 determines “NO” and proceeds to step 1995. In a case where there is the storage device belonging to the secondary layer as a connectable switching candidate, the second storage device 220 determines “YES” and proceeds to step 1920 to proceed to a secondary layer device switching flow illustrated in FIGS. 20A and 20B described later.

Step 1925: The first storage device 210 acquires information of the connectable storage device of the primary layer.

Step 1930: The first storage device 210 calculates an operation score of the switchable storage device. Note that the first storage device 210 calculates the operation score on the basis of the evaluation score table 1200 and the backup table 5000 by operation score fop(s)=(predicted consumption capacity score)×w1 (priority weight)+ (actual operation cost)×w2 (priority weight). In the calculation formula, the predicted consumption capacity score is calculated by predicted consumption capacity score={(full backup capacity+differential backup capacity)}×capacity reduction rate (%), the total operation cost is calculated by total operation cost (yen/month)=assumed capacity cost+assumed I/O cost, and the actual operation cost is calculated by actual operation cost (yen/month)=actual capacity cost+actual I/O cost.

Step 1935: The first storage device 210 determines, as the switching destination, a storage device having a minimum value of the calculated operation scores including the operation score of the storage device currently operated.

Step 1940: The first storage device 210 determines whether or not a connection between the storage device of the switching destination and the storage device of the secondary layer is normal. In a case where the connection between the storage device of the switching destination and the storage device of the secondary layer is not normal, the first storage device 210 determines “NO” and proceeds to step 1945. In a case where the connection between the storage device of the switching destination and the storage device of the secondary layer is normal, the first storage device 210 determines “YES” and proceeds to step 1950 in FIG. 19B.

Step 1945: The first storage device 210 calculates operation scores from the remaining switchable storage devices other than the switching destination storage device determined in step 1925, proceeds to step 1935 again, and determines, as the switching destination, a storage device (the third storage device 230 in this example) having the minimum value of the calculated operation scores from among the remaining switchable storage devices. Thereafter, the storage device proceeds to step 1940 and executes the processing of step 1940 described above.

Step 1950: The third storage device 230 transmits an instruction to restore backup data to the storage device of the secondary layer (the fourth storage device 240 in this example).

Step 1955: The fourth storage device 240 copies the backup data of the secondary layer to the storage device of the primary layer (the third storage device 230 in this example).

Step 1960: The third storage device 230 updates the operation status of the storage device of the primary layer in the backup relationship.

Step 1965: The third storage device 230 transmits, to the first storage device 210 of the storage destination of the original data A, the information regarding the backup data of the third storage device 230 belonging to the primary layer and having the backup relationship (the information regarding the storage device of the primary layer, the storage device of the secondary layer, and the backup data).

Step 1970: The first storage device 210 updates the information (the information regarding storage device of the primary layer, the storage device of the secondary layer, and the backup data) of all the operation statuses of the backup relationship, on the basis of the information received from the third storage device 230 of the primary layer.

Step 1975: The first storage device 210 creates execution information of the recovery process of the backup relationship and stores the execution information in the recovery task table 7100.

Step 1995: The backup system temporarily ends this processing flow.

FIGS. 20A and 20B are flowcharts illustrating the secondary layer device switching flow. The backup system starts processing from step 2000 and proceeds to step 2005.

Step 2005: The second storage device 220 acquires information of the connectable secondary layer storage device.

Step 2010: The second storage device 220 calculates an operation score of the switchable storage device. Note that the second storage device 220 calculates the operation score on the basis of the evaluation score table 1200 by operation score fop(s)=(predicted consumption capacity score)×w1 (priority weight)+ (actual operation cost)×w2 (priority weight). In the calculation formula, the predicted consumption capacity score is calculated by predicted consumption capacity score={(full backup capacity+differential backup capacity)}×capacity reduction rate (%), the total operation cost is calculated by total operation cost (yen/month)=assumed capacity cost+assumed I/O cost, and the actual operation cost is calculated by actual operation cost (yen/month)=actual capacity cost+actual I/O cost.

Step 2015: The second storage device 220 determines, as the switching destination, a storage device having a minimum value of the calculated operation scores including the operation score of the storage device currently operated.

Step 2020: The second storage device 220 determines whether or not a connection between the storage device of the switching destination and the storage device of the primary layer is normal. In a case where the connection between the storage device of the switching destination and the storage device of the primary layer is not normal, the second storage device 220 determines “NO” and proceeds to step 2025. In a case where the connection between the storage device of the switching destination and the storage device of the primary layer is normal, the second storage device 220 determines “YES” and proceeds to step 2030 in FIG. 20B.

Step 2025: The second storage device 220 calculates operation scores from the remaining switchable storage devices other than the switching destination storage device determined in step 2015, proceeds to step 2015 again, and determines, as the switching destination, a storage device (the fifth storage device 250 in this example) having the minimum value of the calculated operation scores from among the remaining switchable storage devices. Thereafter, the storage device proceeds to step 2020 and executes the processing of step 2020 described above.

Step 2030: The fifth storage device 250 transmits an instruction to restore backup data to the storage device of the primary layer (the second storage device 220 in this example).

Step 2035: The second storage device 220 copies the backup data of the primary layer to the storage device of the secondary layer (the fifth storage device 250 in this example).

Step 2040: The fifth storage device 250 updates the operation status of the storage device of the secondary layer in the backup relationship.

Step 2045: The fifth storage device 250 transmits, to the first storage device 210 of the storage destination of the original data A, the information regarding the backup data of the fifth storage device 250 belonging to the secondary layer and having the backup relationship (the information regarding the storage device of the primary layer, the storage device of the secondary layer, and the backup data).

Step 2050: The first storage device 210 updates the information (the information regarding storage device of the primary layer, the storage device of the secondary layer, and the backup data) on all the operation statuses of the backup relationship, on the basis of the information received from the fifth storage device 250 of the secondary layer.

Step 2055: The first storage device 210 creates execution information of the recovery process of the backup relationship and stores the execution information in the recovery task table 7100.

Step 2095: The backup system temporarily ends this processing flow.

### Effects

As described above, the backup system according to the fourth embodiment of the present invention has the same effects as those of the first embodiment. Furthermore, the backup system according to the fourth embodiment of the present invention can efficiently perform the backup operation by optimizing the storage devices (the storage device of the primary layer and the storage device of the secondary layer) forming the backup relationship on the basis of the operation score.

### MODIFICATION

The present invention is not limited to the above embodiments, and various modifications can be adopted within the scope of the present invention. Furthermore, the above-described embodiments can be combined with each other as long as they do not depart from the scope of the present invention.

What is claimed is:

1. A backup system comprising a plurality of backup storage devices for storing backup data of backup target data stored in a storage device, wherein
the plurality of backup storage devices are classified as backup storage devices belonging to either a primary layer or a secondary layer, and
the backup target data is backed up by the storage device storing primary backup data, which is backup data of the backup target data, in the backup storage device belonging to the primary layer, and the backup storage device belonging to the primary layer storing secondary backup data, which is backup data of the primary backup data, in the backup storage device belonging to the secondary layer.

2. The backup system according to claim 1, wherein the storage device determines whether or not a connection state between the storage device and a primary layer backup storage device, which is the backup storage device which belongs to the primary layer and stores the primary backup data, is normal, and determines whether or not a connection state between the primary layer backup storage device and a secondary layer backup storage device, which is the backup storage device which belongs to the secondary layer and stores the secondary backup data, is normal.

3. The backup system according to claim 2, wherein
the storage device switches a storage destination of the primary backup data to another backup storage device belonging to the primary layer in a case where the connection state between the storage device and the primary layer backup storage device is not normal,
the secondary layer backup storage device transmits a copy of the secondary backup data to the other backup storage device belonging to the primary layer as a switching destination,
the other backup storage device belonging to the primary layer as the switching destination restores the primary backup data from the copy of the secondary backup data,
the primary layer backup storage device
switches a storage destination of the secondary backup data to another backup storage device belonging to the secondary layer in a case where the connection state between the primary layer backup storage device and the secondary layer backup storage device is not normal, and
transmits a copy of the primary backup data to the other backup storage device belonging to the secondary layer as a switching destination, and
the other backup storage device belonging to the secondary layer as the switching destination restores the secondary backup data from the copy of the primary backup data.

4. The backup system according to claim 3, wherein
the storage device
in a case where the connection state between the storage device and the primary layer backup storage device is not normal, determines whether or not there is another backup storage device belonging to the primary layer and capable of being switched to,
in a case where there is the other backup storage device belonging to the primary layer and capable of being switched to, switches the storage destination of the primary backup data to the other backup storage device belonging to the primary layer, and
in a case where there is no another backup storage device belonging to the primary layer and capable of being switched to, generates an alert regarding an abnormal state of a backup relationship.

5. The backup system according to claim 3, wherein
the primary layer backup storage device
in a case where the connection state between the primary layer backup storage device and the secondary layer backup storage device is not normal, determines whether or not there is another backup storage device belonging to the secondary layer and capable of being switched to,
in a case where there is the other backup storage device belonging to the secondary layer and capable of being switched to, switches the storage destination of the secondary backup data to the other backup storage device belonging to the secondary layer, and
in a case where there is no another backup storage device belonging to the secondary layer and capable of being switched to, generates an alert regarding an abnormal state of a backup relationship.

6. The backup system according to claim 3, wherein
the storage device
in a case where the connection state between the storage device and the primary layer backup storage device is not normal, determines whether or not there is another backup storage device belonging to the primary layer and capable of being switched to,
in a case where there are a plurality of other backup storage devices belonging to the primary layer and capable of being switched to, calculates operation scores for evaluating operation states of the plurality of other backup storage devices, and selects another backup storage device as a switching destination from among the plurality of other backup storage devices on a basis of the operation scores, and
switches the storage destination of the primary backup data to the selected another backup storage device belonging to the primary layer.

7. The backup system according to claim 3, wherein
the primary layer backup storage device
in a case where the connection state between the primary layer backup storage device and the secondary layer backup storage device is not normal, determines whether or not there is another backup storage device belonging to the secondary layer and capable of being switched to,
in a case where there are a plurality of other backup storage devices belonging to the secondary layer and capable of being switched to, calculate operation scores for evaluating operation states of the plurality of other backup storage devices, and selects another backup storage device as a switching destination from among the plurality of other backup storage devices on a basis of the operation scores, and
switches the storage destination of the secondary backup data to the selected another backup storage device belonging to the secondary layer.

8. The backup system according to claim 3, wherein
the storage device
after the storage destination of the primary backup data is switched to the other backup storage device belonging to the primary layer, determines whether or not a connection state between the storage device and the backup storage device belonging to the primary layer before switching is normal, and
in a case where the connection state between the storage device and the backup storage device belonging to the primary layer before switching is normal, switches the storage destination of the primary backup data from the other backup storage device belonging to the primary layer to the backup storage device belonging to the primary layer before switching.

9. The backup system according to claim 3, wherein
after the storage destination of the secondary backup data is switched to the other backup storage device belonging to the secondary layer, the storage device determines whether or not a connection state between the primary layer backup storage device and the backup storage device belonging to the secondary layer before switching is normal, and
in a case where the connection state between the primary layer backup storage device and the backup storage device belonging to the secondary layer before switching is normal, the primary layer backup storage device switches the storage destination of the secondary backup data from the other backup storage device belonging to the secondary layer to the backup storage device belonging to the secondary layer before switching.

10. The backup system according to claim 8, wherein
the storage device
in a case where the connection state between the storage device and the backup storage device belonging to the primary layer before switching is normal, calculates operation scores for calculating operation states of the backup storage device belonging to the primary layer before switching and another backup storage device belonging to the primary layer after switching, and
in a case where the operation score of the backup storage device belonging to the primary layer before switching is superior to the operation score of the other backup storage device belonging to the primary layer, switches the storage destination of the primary backup data from the other backup storage device belonging to the primary layer to the backup storage device belonging to the primary layer before switching.

11. The backup system according to claim 9, wherein
the primary layer backup storage device
in a case where the connection state between the primary layer backup storage device and the backup storage device belonging to the secondary layer before switching is normal, calculates operation scores for calculating operation states of the backup storage device belonging to the secondary layer before switching and another backup storage device belonging to the secondary layer after switching, and
in a case where the operation score of the backup storage device belonging to the secondary layer before switching is superior to the operation score of the other backup storage device belonging to the secondary layer, switches the storage destination of the secondary backup data from the other backup storage device belonging to the secondary layer to the backup storage device belonging to the secondary layer before switching.

12. The backup system according to claim 1, wherein
the storage device
calculates an operation score for calculating an operation state of another backup storage device belonging to the primary layer, and
determines whether or not to switch a storage destination of the primary backup data to another backup storage device belonging to the primary layer on a basis of the operation score, and switches the storage destination of the primary backup data to the other backup storage device belonging to the primary layer according to a determination result,
the backup storage device which belongs to the secondary layer and stores the secondary backup data transmits a copy of the secondary backup data to the other backup storage device belonging to the primary layer as a switching destination,
the other backup storage device belonging to the primary layer as the switching destination restores the primary backup data from the copy of the secondary backup data,
the backup storage device which belongs to the primary layer and stores the primary backup data
calculates an operation score for calculating an operation state of another backup storage device belonging to the secondary layer, and
determines whether or not to switch a storage destination of the secondary backup data to the other backup storage device belonging to the secondary layer on a basis of the operation score, and switches the storage destination of the secondary backup data to the other backup storage device belonging to the secondary layer according to a determination result,
the backup storage device which belongs to the primary layer and stores the primary backup data transmits a copy of the primary backup data to the other backup storage device belonging to the secondary layer as a switching destination, and
the other backup storage device belonging to the secondary layer as the switching destination restores the secondary backup data from the copy of the primary backup data.

13. A backup method using a plurality of backup storage devices for storing backup data of backup target data stored in a storage device, wherein
the plurality of backup storage devices are classified as backup storage devices belonging to either a primary layer or a secondary layer, and
the backup target data is backed up by the storage device storing primary backup data, which is backup data of the backup target data, in the backup storage device belonging to the primary layer, and the backup storage device belonging to the primary layer storing secondary backup data, which is backup data of the primary backup data, in the backup storage device belonging to the secondary layer.
